(19) United States
(12) Patent Application Publication
(10) Pub. No.: US 2013/0101722 A1
(43) Pub. Date: Apr. 25, 2013

(54) CHOCOLATE BEVERAGE CONTAINING NITROUS OXIDE AND CARBON DIOXIDE

(71) Applicants: Adrian M. Sepcic, Frisco, TX (US); Rein Hirs, Plano, TX (US)

(72) Inventors: Adrian M. Sepcic, Frisco, TX (US); Rein Hirs, Plano, TX (US)

(21) Appl. No.: 13/656,022

(22) Filed: Oct. 19, 2012

Related U.S. Application Data
(63) Continuation-in-part of application No. 12/563,261, filed on Sep. 21, 2009, now abandoned.
Application No. 12/563,261 is a continuation-in-part of application No. 12/371,181, filed on Feb. 13, 2009.
Application No. 12/371,181 is a continuation of application No. 11/972,683, filed on Jan. 11, 2008, now abandoned.
Application No. 11/972,683 is a continuation-in-part of application No. 11/775,932, filed on Jul. 11, 2007.
(60) Provisional application No. 60/807,351, filed on Jul. 14, 2006.

(51) Int. Cl. A23L 2/54

(52) U.S. Cl. CPC A23L 2/54
USPC 426/548; 426/593

(57) ABSTRACT

Disclosed herein are beverage compositions containing dissolved gases. The beverage compositions generally contain a mixture of dissolved nitrous oxide and dissolved carbon dioxide. Beverage compositions disclosed herein may include a chocolate flavor.

### CROSS REFERENCE TO RELATED APPLICATIONS

This application is a continuation-in-part of U.S. Nonprovisional application Ser. No. 12/563,261 filed Sep. 21, 2009, which is a continuation-in-part of U.S. Nonprovisional application Ser. No. 12/371,181 filed Feb. 13, 2009, which is a continuation of U.S. Nonprovisional application Ser. No. 11/972,683 filed Jan. 11, 2008, which is a continuation-in-part of U.S. Nonprovisional application Ser. No. 11/775,932 filed Jul. 11, 2007, which in turn claims priority to U.S. Provisional Application Ser. No. 60/807,351 filed Jul. 14, 2006. The disclosure of each of the aforementioned applications is incorporated herein by reference.

### FIELD

In some embodiments, oral liquid compositions comprising dissolved gases, including dissolved nitrous oxide in combination with dissolved carbon dioxide are provided. In other embodiments, foam-creating compositions, foaming beverage compositions, and methods of preparing such compositions are provided. In other embodiments, chocolate flavored beverages comprising dissolved gases including nitrous oxide are provided.

### BACKGROUND

Foaming beverages, such as root beer and root beer floats prepared from vanilla ice cream and root beer, provide a drinkable beverage having a distinctive frothy foam head. Floats also have the creamy mouth feel imparted by the addition of the ice cream. Root beer typically has the frothy foam head imparted by the combination of carbonation and foaming agents such as yucca schidigera extract.

A disadvantage of traditional floats is the inconvenience of preparation, as the separate ingredients must be combined prior to consumption. Root beer, although providing a good foamy head when poured, requires carbonation for the foam preparation. A further drawback of traditional root beer is that it does not provide a thick, creamy mouth feel as found in float beverages.

There is a need for new foaming compositions, which provide the desired advantage of convenience, foam stability, and mouth feel. The foam of such compositions would desirably be achieved with or without the need for carbonation. A further need is for the foaming composition to be prepared in a convenient form, which can be further formulated into a beverage concentrate, syrup, or final beverage.

Texture and mouthfeel are also characteristics that may be desired in chocolate beverages. Foaming compositions may be used to impart such characteristics to chocolate beverages. However, some consumers may prefer chocolate beverages that are not foaming or consumers may prefer chocolate beverages that do not include or minimize a proportion of a dairy and/or fat component. There is a need for beverages including chocolate or chocolate-flavored beverages which include a level of texture and mouthfeel and which improve the quality of chocolate flavor and aftertaste.

In recent years, the food industry has focused on products which incorporate high intensity sweeteners (non-nutritive sweeteners) as low calorie sweetener substitute to sucrose and other conventional low sweetness high calorie sweeteners. However, when high intensity sweeteners are used as the only source of sweetness in preparation of liquid oral compositions, such as beverages or pharmaceutical compositions etc., the taste and organoleptic feel with respect to many subtle features such as physical consistency, texture (such as dryness, moistness, brittleness etc.), flavour, aftertaste etc. are seen to be not equally same as that are available when sucrose or other conventional high calorie sweetener is used at same degree of relative sweetness.

The lack of same organoleptic feel arises on account of several problems such as bitter, metallic or otherwise unpleasant aftertaste etc. associated with use of high intensity sweeteners. As a result, the liquid oral compositions in which they are used are not as agreeable to taste as they are when sweetening agent is conventional high calorie sweetener alone, such as sucrose. This problem is further aggravated by the fact that high intensity sweeteners contribute only to sweetness and not to many other food properties which are contributed by conventional sweeteners, which are high calorie sweeteners, including sucrose. Hence, while high intensity sweeteners are a logical alternative choice to augment sweetness despite reduction in the use of sucrose for the purpose of reducing calories or sugar intake in the diet, doing so without losing sucrose/sugar-specific taste properties is a big challenge.

There is a need for new liquid oral compositions including high intensity sweeteners having the desired sweetness, flavour, texture and similar subtle organoleptic properties of the low calorie, high intensity sweeteners.

### SUMMARY

Disclosed herein is a liquid oral composition comprising a high intensity sweetener component having a lingering bitter aftertaste; and dissolved gas consisting of a mixture of nitrous oxide and carbon dioxide in a volume/volume ratio of about 75:25 to about 25:75, wherein the composition contains about 1.0 to about 4.5 volumes of dissolved gas, and wherein the dissolved N₂O is in an amount sufficient to reduce the lingering aftertaste of the non-nutritive sweetener component.

Disclosed herein is a chocolate beverage including dissolved gas comprising a mixture of nitrous oxide and carbon dioxide in a volume/volume ratio of about 75:25 to about 25:75, wherein the composition contains about 1.0 to about 4.5 volumes of dissolved gas, and wherein the dissolved N₂O is in an amount sufficient to improve one or more of a milk chocolate aroma, milk chocolate flavor, or milk chocolate aftertaste.

Disclosed herein is a chocolate beverage including dissolved gas comprising a mixture of nitrous oxide and carbon dioxide in a volume/volume ratio of about 75:25 to about 25:75, wherein the composition contains about 1.0 to about 4.5 volumes of dissolved gas, and wherein the dissolved N₂O is in an amount sufficient to improve the milk chocolate aroma and/or caramel aroma of the beverage.

Disclosed herein is a chocolate beverage including dissolved gas comprising a mixture of nitrous oxide and carbon dioxide in a volume/volume ratio of about 75:25 to about 25:75, wherein the composition contains about 1.0 to about 4.5 volumes of dissolved gas, and wherein the dissolved N₂O is in an amount sufficient to improve one or more of the sweet flavor, milk chocolate flavor, and/or caramel flavor of the beverage.

Disclosed herein is a chocolate beverage including dissolved gas comprising a mixture of nitrous oxide and carbon dioxide in a volume/volume ratio of about 75:25 to about 25:75, wherein the composition contains about 1.0 to about 4.5 volumes of dissolved gas, and wherein the dissolved N₂O is in an amount sufficient to increase or prolong a sweet aftertaste and/or milk chocolate aftertaste.

Disclosed herein is a chocolate beverage including dissolved gas comprising a mixture of nitrous oxide and carbon dioxide in a volume/volume ratio of about 75:25 to about 25:75, wherein the composition contains about 1.0 to about 4.5 volumes of dissolved gas, and wherein the dissolved N₂O is in an amount sufficient to increase the mouthfeel and texture of a beverage.

Disclosed herein is a method of reducing a metallic aftertaste in a liquid oral composition comprising dissolving about 1.0 to about 4.5 volumes of dissolved gas consisting of a mixture of nitrous oxide and carbon dioxide in a liquid oral composition, wherein the mixture of nitrous oxide and carbon dioxide is present in a volume/volume ratio of about 75:25 to about 25:75, wherein the dissolved N₂O is in an amount sufficient to reduce the lingering metallic aftertaste in the liquid oral composition.

Disclosed herein is a method of reducing a metallic after-taste in a liquid oral composition comprising a high intensity sweetener, the method comprising dissolving about 1.0 to about 4.5 volumes of CO₂ and N₂O at ratio of about 50:50 in a liquid oral composition, wherein the liquid oral composition has a metallic after-taste, wherein the dissolved N₂O is in an amount sufficient to reduce the lingering metallic aftertaste in the liquid oral composition.

Disclosed herein is a carbonated beverage comprising dissolved N₂O in an amount effective to mask a lingering aftertaste, wherein the CO₂ and N₂O are present in the beverage at a ratio of about 50:50.

Disclosed herein is a beverage comprising a high intensity sweetener; and from about 1.0 to about 4.5 volume (%) of dissolved CO₂ and N₂O, wherein the beverage is substantially free from the bitter off note associated with the high intensity sweetener.

Also disclosed herein is a method of masking undesirable tastes in a beverage without adding calories to the beverage, the method comprising dissolving about 1.0 to about 4.5 volume (%) of CO₂ and N₂O in the beverage at a ratio of about 50:50.

Disclosed herein is a reduced calorie beverage comprising a non-nutritive sweetener component having a lingering bitter aftertaste; and dissolved N₂O in an amount sufficient to reduce the lingering bitter aftertaste of the non-nutritive sweetener component.

Disclosed herein is a foam-creating composition comprising about 2 to about 95 wt % dairy composition based on the total weight of the foam-creating composition, wherein the dairy composition comprises a dairy protein; a hydrocolloid composition; and a foam stabilizer; wherein the foam-creating composition comprises a ratio of dairy protein to hydrocolloid of about 3:1 wt/wt to about 1:4 wt/wt.

In another embodiment, a pre-mixed, ready-to-drink foaming beverage comprises a foam-creating composition comprising a dairy composition, a hydrocolloid composition, and a foam stabilizer; wherein the foam-creating composition comprises about 2 to about 95 wt % of the dairy composition based on the total weight of the foam-creating composition, and wherein the dairy composition comprises a dairy protein; and wherein the foam-creating composition comprises a ratio of dairy protein to hydrocolloid of about 3:1 wt/wt to about 1:4 wt/wt.

In yet another embodiment, a pre-mixed, ready-to-drink foaming beverage, comprises: a foam-creating composition comprising a dairy composition, a hydrocolloid composition, and a foam stabilizer; and dissolved gas consisting of a mixture of nitrous oxide and carbon dioxide in volume/volume ratio of about 25:75 to about 75:25; wherein the foam-creating composition comprises about 2 to about 95 wt % of the dairy composition based on the total weight of the foam-creating composition, and wherein the dairy composition comprises a dairy protein; and wherein the foam-creating composition comprises a ratio of dairy protein to hydrocolloid of about 3:1 wt/wt to about 1:4 wt/wt.

In yet another embodiment, a method of preparing a foaming beverage comprises providing a foam-creating composition comprising a dairy composition, a hydrocolloid composition, and a foam stabilizer, wherein the dairy composition comprises a dairy protein; and dispersing the foam-creating composition in an liquid composition to form a beverage; wherein the foam-creating composition comprises a ratio of dairy protein to hydrocolloid of about 3:1 wt/wt to about 1:4 wt/wt.

In still another embodiment, a beverage concentrate comprises a foam-creating composition comprising a dairy composition, a hydrocolloid composition, and a foam stabilizer; and a flavoring agent; wherein the foam-creating composition comprises about 2 to about 95 wt % of the dairy composition based on the total weight of the foam-creating composition, and wherein the dairy composition comprises a dairy protein; and wherein the foam-creating composition comprises a ratio of dairy protein to hydrocolloid of about 3:1 wt/wt to about 1:4 wt/wt.

In one embodiment, a bottling syrup comprises a foam-creating composition comprising a dairy composition, a hydrocolloid composition, and a foam stabilizer; a flavoring agent; and a sweetening agent; wherein the foam-creating composition comprises about 2 to about 95 wt % of the dairy composition based on the total weight of the foam-creating composition, and wherein the dairy composition comprises a dairy protein; and wherein the foam-creating composition comprises a ratio of dairy protein to hydrocolloid of about 3:1 wt/wt to about 1:4 wt/wt.

In another embodiment, a fountain syrup comprises a foam-creating composition comprising a dairy composition, a hydrocolloid composition, and a foam stabilizer; a flavoring agent; and a sweetening agent; wherein the foam-creating composition comprises about 2 to about 95 wt % of the dairy composition based on the total weight of the foam-creating composition, and wherein the dairy composition comprises a dairy protein; and wherein the foam-creating composition comprises a ratio of dairy protein to hydrocolloid of about 3:1 wt/wt to about 1:4 wt/wt.

In another embodiment, a method of preparing a foam-creating composition comprises providing a hydrocolloid composition, a dairy composition comprising a dairy protein, and a foam stabilizer; and dispersing the hydrocolloid composition, the dairy composition, and the foam stabilizer in a liquid composition to form a foam-creating composition; wherein the ratio of dairy protein to hydrocolloid is about 3:1 w/w to about 1:4 w/w.

In still another embodiment, a method of stabilizing foam in a beverage comprises preparing a beverage composition, a bottling syrup, a fountain syrup, or a beverage concentrate to comprise an amount of a foam-creating composition to stabilize a foam in a beverage, wherein the foam-creating composition comprises a dairy composition, a hydrocolloid composition, and a foam stabilizer; wherein the dairy composition comprises a dairy protein; and wherein the foam-creating composition comprises a ratio of dairy protein to hydrocolloid of about 3:1 wt/wt to about 1:4 wt/wt.

In yet another embodiment, a method of creating foam in a beverage comprises preparing a beverage composition comprising an amount of a foam-creating composition; optionally shaking the beverage composition; and dispensing the beverage to form a foam; wherein the foam-creating composition comprises a dairy composition, a hydrocolloid composition, and a foam stabilizer; wherein the dairy composition comprises a dairy protein; and wherein the foam-creating composition comprises a ratio of dairy protein to hydrocolloid of about 3:1 wt/wt to about 1:4 wt/wt.

In yet another embodiment, a kit comprises a foam-creating composition, and a communication that dispensing the composition creates foam; wherein the foam-creating composition comprises about 2 to about 95 wt % dairy composition based on the total weight of the foam-creating composition, wherein the dairy composition comprises a dairy protein; a hydrocolloid composition; and a foam stabilizer; wherein the foam-creating composition comprises a ratio of dairy protein to hydrocolloid of about 3:1 wt/wt to about 1:4 wt/wt.

In yet another embodiment, a kit comprises a beverage and a communication that dispensing the beverage creates a foam; wherein the beverage is a pre-mixed, ready-to-drink foaming beverage, comprising a foam-creating composition comprising a dairy composition, a hydrocolloid composition, and a foam stabilizer; wherein the foam-creating composition comprises about 2 to about 95 wt % of the dairy composition based on the total weight of the foam-creating composition, and wherein the dairy composition comprises a dairy protein; and wherein the foam-creating composition comprises a ratio of dairy protein to hydrocolloid of about 3:1 wt/wt to about 1:4 wt/wt.

The above described and other features are exemplified by the following figures and detailed description.

### BRIEF DESCRIPTION OF THE DRAWINGS

FIG. 1A is a top of view of an adapter used in Examples 5-124 to join a beverage bottle to a graduated cylinder.

FIG. 1B is a perspective side view of an adapter used in Examples 5-124 to join a beverage bottle to a graduated cylinder.

FIG. 2A depicts a beverage bottle and a graduated cylinder joined by an adapter before transfer of the beverage composition from the bottle to the cylinder.

FIG. 2B depicts a beverage bottle and a graduated cylinder joined by an adapter after transfer of the beverage composition from the bottle to the cylinder.

FIG. 3 is a graph demonstrating the overall liking of several beverages containing varying amounts of dissolved nitrous oxide and carbon dioxide.

FIG. 4 is a graph demonstrating the mouthfeel liking of several beverages containing varying amounts of dissolved nitrous oxide and carbon dioxide.

FIG. 5 is a graph demonstrating the aftertaste liking of several beverages containing varying amounts of dissolved nitrous oxide and carbon dioxide.

FIG. 6 is a graph demonstrating the flavor liking of several beverages containing varying amounts of dissolved nitrous oxide and carbon dioxide.

FIG. 7 is a graph demonstrating the descriptive results when comparing five lemon tea product samples.

FIG. 8 is a graph demonstrating the descriptive results when comparing a carbonated chocolate beverage and a chocolate beverage including dissolved nitrous oxide.

FIG. 9 is a graph including a subset of the descriptive results data included in FIG. 8.

### DETAILED DESCRIPTION

The following terms as used herein should be understood to have the indicated meanings.

When an item is introduced by “a” or “an,” it should be understood to mean one or more of that item.

“Comprises” means includes but is not limited to.

“Comprising” means including but not limited to.

“Having” means including but not limited to.

The term “consumable item” means anything that may be orally ingested by a consumer, including without limitation a food, beverage, pharmaceutical composition, nutraceutical composition, vitamin, lozenge, dietary supplement, confection, chewing gum, candy and a combination of any of the foregoing.

The term “chocolate beverage” as used herein means any drinkable liquid or semi-liquid that upon consumption imparts one or more chocolate flavors. A chocolate beverage may include one or more natural ingredients derived from the cacao tree, and may also include other natural or artificial ingredients that impart one or more chocolate flavors. By way of nonlimiting example, chocolate flavors include milk chocolate flavor, dark chocolate flavor, other chocolate-like flavors, and a combination of any of the foregoing.

Disclosed herein are foam-creating compositions, which can be incorporated into a concentrate, a bottling syrup, a fountain syrup, or a beverage including ready-to-drink beverages; and methods of preparing the foam-creating composition, concentrates, syrups, and beverages. Particularly, the foam-creating compositions comprise a dairy composition, a hydrocolloid composition, and a foam stabilizer, wherein the dairy composition comprises a dairy protein. Also disclosed herein are chocolate beverages that may or may not incorporate a foam-creating composition. The chocolate beverages herein may, in some embodiments, include a dissolved gas such as nitrous oxide, carbon dioxide or both.

The chocolate beverages disclosed herein may, in some embodiments, include one or more high intensity or other sweeteners that provide lower calorie content for the same sweetness level as compared to natural sugar. For example, in some embodiments, a chocolate beverage may include one or more high intensity sweetener, non-nutritive sweetener, or a combination of both. In some embodiments, a chocolate beverage may include one or more of sucralose, stevia, acesulfame-potassium, aspartame and combinations thereof. A chocolate beverage may, in some embodiments, further include a proportion of added sucrose. Sucrose present in a chocolate beverage may be provided as a portion of a chocolate concentrate, may be added as an ingredient separate from the chocolate concentrate or may be provided from both sources.

In some embodiments, a chocolate beverage may include a level of dissolved nitrous oxide sufficient to increase the level of a sweet flavor, milk chocolate flavor, and/or caramel flavor of a beverage. Using dissolved nitrous oxide to increase the level of a sweet flavor may facilitate the production of chocolate beverages, such as, for example, chocolate beverages prepared from a fudge-flavored concentrate, that include reduced amounts of sugars and reduced calorie contents as compared to other beverages that do not incorporate dissolved nitrous oxide. In addition, in some embodiments, a chocolate beverage may include a level of dissolved nitrous oxide sufficient to improve the texture and/or mouthfeel of a beverage with reduced sugar and/or fat content as compared to other chocolate flavored drinks For example, chocolate beverages that include dissolved gas may possess a chocolate flavor, may be low in fat, carbohydrate and/or calorie content and yet maintain a smooth and desirable mouthfeel not found in other chocolate beverages without dissolved nitrous oxide.

In some embodiments, a chocolate beverage may include a dissolved gas comprising a mixture of nitrous oxide and carbon dioxide in a volume/volume ratio of about 75:25 to about 25:75, wherein the composition contains about 1.0 to about 4.5 volumes of the dissolved gases. In some embodiments, the chocolate beverage may provide upon consumption a calorie content of between about 2 to about 8 calories per fluid ounce. In some embodiments, a chocolate beverage including dissolved nitrous oxide may provide a calorie content of between about 4 to about 6 calories per fluid ounce.

Beverages prepared from the foam-creating compositions exhibit a creamy foam head when poured. In some embodiments, the foam-creating composition forms a cream foam head when shaken and poured. The foam head formed is more stable than corresponding compositions free of the foam-creating composition. Additionally, when the foam-creating composition is incorporated into a carbonated beverage or a beverage containing dissolved gas under pressure, the loss of carbonation/gas over time is significantly reduced as compared to similar beverages free of the foam-creating composition.

The foam-creating composition generally comprises a dairy composition, wherein the dairy composition contains a dairy protein. Exemplary dairy compositions include any type of dairy product including cream, whole milk, reduced fat milk, skim milk, milk solids, condensed milk, or a combination comprising at least one of the foregoing milk products, specifically a combination of cream and skim milk.

The dairy composition generally comprises an amount of dairy protein, for example whey protein containing beta-lactoglobulin, alpha-lactalbumin, or serum albumin; and the like. Depending upon the dairy product and how it is processed, the amount of protein present can vary. For example, skim milk generally contains about 7.5 weight percent (wt %) protein, whole milk contains about 3.4-3.5 wt % protein, while cream can contain about 1.67 wt % protein, on average.

The dairy product used to prepare the foam-creating composition may be replaced in part with an amount of a non-dairy component such as soy milk, soy protein, almond milk, coconut milk, or a combination comprising at least one of the foregoing.

The dairy composition is present in the foam-creating composition in an amount of about 2 to about 95 wt % based on the total weight of the foam-creating composition, specifically about 5 to about 90 wt %, more specifically about 15 to about 85 wt %, still more specifically about 55 to about 85 wt %, and yet more specifically about 55 to about 75 wt %.

The foam-creating composition further comprises a hydrocolloid composition, which when combined with the dairy composition and the foam stabilizer, provides a composition with excellent foam-creating properties. The hydrocolloid composition generally can contain a natural gum, a synthetic gum, a starch, a modified starch, pectin, gelatin, an alginate, a modified alkylcellulose, or a combination comprising at least one of the foregoing. Specifically, the hydrocolloid composition includes propylene glycol alginate, gum arabic, pectin, locust bean gum, guar gum, gellan gum, xanthan gum, gum ghatti, modified gum ghatti, tragacanth gum, carrageenan, pregelatinized starch, pregelatinized high amylose-content starch, pregelatinized hydrolyzed starches, pregelatinized octenyl succinate substituted starch, a carboxymethylcellulose, or a combination comprising at least one of the foregoing.

In one embodiment, the foam-creating composition comprises a combination of propylene glycol alginate, gum arabic, and pectin.

The hydrocolloid composition can be present in the foam-creating composition in an amount of about 0.2 to about 20 wt % based on the total weight of the foam-creating composition, specifically about 0.5 to about 15 w %, more specifically about 1.0 to about 10 wt %, and yet more specifically about 2.0 to about 5.0 wt %.

It has been found that the foam-creating composition having a particular ratio of dairy protein to total hydrocolloid results in a composition that provides good foam-creating properties. In one embodiment, the foam-creating composition comprises a ratio of dairy protein to hydrocolloid of about 3:1 wt/wt to about 1:4 wt/wt, specifically about 2:1 wt/wt to about 1:3, more specifically about 1:1 wt/wt to about 1:2 wt/wt, and yet more specifically about 1:1.5 to about 1:1.8.

In addition to the dairy composition and the hydrocolloid composition, the foam-creating composition may comprise a foam stabilizer. A foam stabilizer is a compound or mixture of compounds that increases the longevity of foam created by the foam-creating composition. Representative foam stabilizers include, for example, foam stabilizers selected from the group consisting of yucca schidigera extracts, quillaia extracts, Labiatae herb extracts, carnosic acid, esters of camosic acid (including methyl carnosate and ethyl camosate), carnosol, rosmariquinone, rosmanol, epi-rosmanol, isorosmanol, rosmaridiphenol, 12-methoxycarnosic acid, Sophorajaponica saponin, enzyme-treated lecithins, enzyme-digested lecithins, plant sterols, plant lecithins, sphingolipids, soybean saponin, bile powder, animal sterols, tomato glucolipids, fractionated lecithins, barley husk extract, enzyme-treated soybean saponin extract, tea seed saponin, beet saponin, propylene glycol fatty acid esters, sarsaparilla extracts, sorbitan fatty acid esters, sucrose fatty acid esters, and mixtures thereof. In some embodiments, the foam stabilizer comprises yucca schidigera extracts, quillaia extracts, or a mixture thereof. In some embodiments, the foam stabilizer consists of yucca schidigera extract and quillaia extract.

Based on the total weight of a foam-creating composition, the foam stabilizer may generally be present in an amount of about 0.001 to about 10 wt %, specifically 0.005 to about 5 wt %, more specifically 0.01 to 1 wt %. Based on the total weight of a beverage concentrate or a beverage syrup, the foam stabilizer may generally be present in an amount of about 0.001 to about 5 wt %, specifically 0.005 to about 1 wt %, more specifically 0.01 to 0.2 wt %. Based on the total weight of a ready-to-drink beverage, the foam stabilizer may generally be present in an amount of about 0.001 to about 1 wt %, specifically 0.005 to about 0.5 wt %, more specifically 0.01 to 0.2 wt %.

The foam-creating composition may further comprise an amount of fat, which can be derived from the dairy component or added as a separate component. The fat may be present in an amount of about 0.01 to about 5.0 wt % based on the total weight of the foam-creating composition, specifically about 0.1 to about 4.0 wt %, and yet more specifically about 1.0 to about 2.5 wt %.

The foam-creating composition can be formulated into a syrup, a concentrate, or a beverage composition as described herein.

The term “beverage concentrate” or “beverage base” as used herein means an intermediate beverage product which, when mixed with a sweetening agent or an appropriate amount of water or other suitable liquid or semi-liquid, forms a beverage syrup or alternatively a beverage. The beverage concentrate generally comprises a flavoring agent and optional additives. A beverage concentrate may, in some embodiments, include one or more natural ingredients derived from the cacao tree that imparts a chocolate flavor to a beverage prepared from the concentrate. A beverage concentrate may additionally or alternatively include other artificial or natural flavors that impart a chocolate flavor. By way of nonlimiting example, chocolate flavors include milk chocolate flavor, dark chocolate flavor, other chocolate-like flavors, and a combination of any of the foregoing. A beverage concentrate may, in some embodiments, be a fudge or fudge-flavored concentrate.

The term “beverage syrup” as used herein means an intermediate beverage product prepared from a beverage concentrate, a sweetening agent, or an amount of water or other suitable liquid or semi-liquid. The beverage syrup is in a concentrated form that can be diluted to form a beverage. The beverage syrup generally comprises a flavoring agent, a sweetening agent, and optional additives such as food-grade acids, coloring agents, and the like.

Concentrate compositions typically comprise a flavoring agent in a volume of liquid medium that is less than the volume of liquid medium found in a finished beverage composition. Other optional components in the concentrate include sweetening agents, coloring agents, and other additives such as food-grade acids, preservatives, and the like. The bulk of the liquid component of a finished beverage composition is not present in the concentrate to allow for reduced weight, volume, storage and shipping costs while at the same time allowing for increased shelf life of the concentrate versus beverage composition.

In one embodiment, the concentrate composition is formulated to provide final beverage compositions upon dilution with about a 2-fold to about a 5-fold by volume, specifically about 3-fold to about a 4-fold by volume of a liquid. The liquid can be water, juice, dairy component, a non-dairy milk, ethanol, a tea, a coffee, a combination comprising at least one of the foregoing, and the like. The liquid can be in noncarbonated or carbonated form.

One embodiment is a bottling syrup comprising a foam-creating composition comprising a dairy composition, a hydrocolloid composition, and a foam stabilizer; a flavoring agent; and a sweetening agent; wherein the foam-creating composition comprises about 2 to about 95 wt % of the dairy composition based on the total weight of the foam-creating composition, and wherein the dairy composition comprises a dairy protein; and wherein the foam-creating composition comprises a ratio of dairy protein to hydrocolloid of about 3:1 wt/wt to about 1:4 wt/wt.

One embodiment is a fountain syrup comprising a foam-creating composition comprising a dairy composition, a hydrocolloid composition, and a foam stabilizer; a flavoring agent; and a sweetening agent; wherein the foam-creating composition comprises about 2 to about 95 wt % of the dairy composition based on the total weight of the foam-creating composition, and wherein the dairy composition comprises a dairy protein; and wherein the foam-creating composition comprises a ratio of dairy protein to hydrocolloid of about 3:1 wt/wt to about 1:4 wt/wt.

The foam-creating composition can be used to prepare a beverage composition by the addition of a suitable amount of a liquid such as water, juice, gel drinks, coffee, tea, an additional dairy product, a non-dairy product, alcohol component, or a combination comprising at least one of the foregoing liquids. The term “beverage” as used herein means any drinkable liquid or semi-liquid, including for example flavored water, soft drinks, fruit drinks, coffee-based drinks, tea-based drinks, juice-based drinks, milk-based drinks, carbonated or non-carbonated drinks, alcoholic or non-alcoholic drinks.

The beverage composition can contain the foam-creating composition and the liquid, wherein the liquid is present in an amount of up to about 99 wt % based on the total weight of the beverage composition, specifically about 0.1 to about 95 wt %, more specifically about 5.0 to about 80 wt %, and yet more specifically about 50 to about 70 wt %.

The compositions described herein can contain a portion of added water. As used herein “added water” does not include water incidentally added to the composition through other components such as a dairy component or a fruit juice component, for example. The beverage compositions can contain up to about 99 weight percent (wt %) added water based on the total weight of the composition, specifically about 0.1 to about 90 wt %, more specifically about 1.0 to about 80 wt %, and yet more specifically about 5.0 to about 70 wt % added water each based on the total weight of the composition.

The added water can be purified or treated prior to use using processes well-known in the art such as filtration, deionization, distillation, or reverse osmosis.

The foam-creating composition or beverage composition can contain a juice-based composition-obtained from fruit or vegetable. The juice-based composition can be used in any form such as a juice form, a concentrate, an extract, a powder (which can be reconstituted with water or other suitable liquids), or the like.

Suitable juices used in the juice-based composition include, for example, citrus juice, non-citrus juice, or mixtures thereof, which are known for use in beverages. Examples of such juices include, non-citrus juices such as apple juice, grape juice, pear juice, nectarine juice, currant juice, raspberry juice, gooseberry juice, blackberry juice, blueberry juice, strawberry juice, custard-apple juice, pomegranate juice, guava juice, kiwi juice, mango juice, papaya juice, watermelon juice, cantaloupe juice, cherry juice, cranberry juice, peach juice, apricot juice, plum juice, and pineapple juice; citrus juices such as orange juice, lemon juice, lime juice, grapefruit juice, and tangerine juice; and vegetable juice such as carrot juice and tomato juice; and a combination comprising at least one of the foregoing juices.

Unless otherwise indicated, juice as used can include fruit or vegetable liquids containing a percentage of solids derived from the fruit or vegetable, for example pulp, seeds, skins, fibers, and the like, and pectin, which is naturally occurring in the fruit or vegetable. The amount of solids in the juice can be about 1 to about 75 wt %, specifically about 5 to about 60 wt %, more specifically about 10 to about 45 wt %, and yet more specifically about 15 to about 30 wt % each based on the total weight of the juice. Higher concentrations of solids can be found in juice concentrates, purees, and the like.

The amount of juice component present in the composition generally can be about 0.1 wt % to about 95 wt % based on the total weight of the composition, specifically about 5 wt % to about 75 wt %, and more specifically about 10 wt % to about 50 wt % each based on the total weight of the composition. Amounts may vary depending upon whether the composition is a concentrate or a ready to drink beverage, for example. The remaining components in the juice-based composition can be added water or other suitable liquid, a sweetening agent, a flavoring agent, or other additives as described herein.

The juice-based composition can be non-carbonated or carbonated.

In one embodiment, the juice-based composition is fortified with solubilized calcium in the form of calcium carbonate, calcium lactate, calcium oxide, or calcium hydroxide, for example. A food-grade acid can be added to the calcium fortified juice-based composition to improve the solubility of calcium. Exemplary food-grade acids suitable for use in the juice-based composition are further discussed herein, specifically citric acid, malic acid, and a combination comprising at least one of the foregoing food-grade acids.

In some embodiments, the juice-based composition can be formed from a fruit or vegetable using a hot break or cold break process. In both processes, the fruit or vegetable is macerated and passed through conventional equipment to separate out seeds, skins and other undesired solids. The composition is then concentrated by conventional techniques. In hot break processes, the fruit or vegetable is typically heated during maceration or immediately thereafter to deactivate enzymes that may degrade the product and decrease the viscosity of the product. In cold break processes, the fruit or vegetable typically are processed at lower temperatures than hot break. A hot break process accordingly may provide a thicker product than those produced by a cold break process.

In one embodiment, the juice-based composition is pasteurized to destroy unwanted microorganisms. Suitable pasteurization conditions of juice-based compositions can be selected by one of ordinary skill in the art without undue experimentation using the guidelines provided. An exemplary pasteurization process to sterilize the juice-based composition is by heating the composition to about 60 to about 80° C. for about 6 to about 15 minutes in an aseptic environment.

In another embodiment, the juice-based composition is combined with the foam-creating composition and filled into a beverage container and then subjected to pasteurization conditions. Alternatively, the juice-based composition is combined with the foam-creating composition and then hot-filled into a beverage container at temperatures sufficient to sterilize the composition in the container.

In another embodiment, the juice-based composition can contain a preservative allowing the composition to be blended with pasteurized foam-creating composition and then cold-filled into a beverage container without the need for pasteurization. Specifically, the preservatives can be added to lower the pH level of the beverage to pH of about 3 to about 4.5. Suitable preservatives are discussed in detail herein.

The foam-creating composition can be used to prepare a beverage composition by the addition of a suitable amount of an additional liquid dairy product or a non-dairy product.

The foam-creating composition can be mixed with the additional dairy product or non-dairy product, pasteurized and optionally blended with other components including a flavoring agent, a sweetening agent, other additives, or water or other suitable liquid to form a beverage composition. The blending can be performed under aseptic conditions to ensure product integrity.

Suitable conditions for the pasteurization of the foam-creating composition or dairy-based beverage can be selected by one of ordinary skill in the art without undue experimentation using the guidelines provided. An exemplary pasteurization process to sterilize the composition can be effected at temperatures of about 130 to about 140° C. for about 30 seconds to about 2 minutes in an aseptic environment. Alternatively, the pasteurization can be performed at about 115 to about 125° C. for about 20 to about 30 minutes in an aseptic environment. The pasteurized composition can then be packaged. In another embodiment, the composition is filled into a beverage container and then subjected to the pasteurization conditions.

In one embodiment, the foam-creating composition and resulting beverage is lactose free.

The foam-creating composition can be used to prepare a beverage composition by the addition of a suitable amount of an alcohol composition. Examples of suitable alcohol compositions include, hop/malt/grain-based alcohol composition such as ale, lager, shandy, beer, including low alcohol beers (“near beer”), etc.; cider, spirit, liqueur, wine, or a combination comprising at least one of the foregoing. In some embodiments, the level of alcohol, as measured by the amount of ethanol contained in the beverage composition can be about 0.1 to about 20 volume % based on the total volume of the beverage composition.

In one embodiment, the foam-creating composition can be used to prepare a beverage composition by the addition of a suitable amount of a non-alcoholic hop/malt/grain-based composition.

The beverages prepared from the foam-creating composition can contain a dissolved gas under pressure such as carbon dioxide, nitrogen, oxygen, or nitrous oxide. In some embodiments, the dissolved gas is a mixture of nitrous oxide and carbon dioxide in a volume/volume ratio of 25:75 to 75:25, specifically 40:60 to 60:40, more specifically about 50:50. The beverages can contain about 0.1 to about 5.0 volumes of a suitable gas per volume of the beverage composition, and more specifically about 1.0 to about 4.5 volumes. The gas can be provided in the beverage by forceful introduction of the gas under pressure to the beverage composition. Cooling the beverage composition allows for greater amounts of gas to be solubilized by the beverage composition.

The addition of a dissolved gas may, in some embodiments, be used to enhance the flavor, sweetness, taste, and mouth-feel of the composition. Additionally, for those embodiments that include carbonation, carbonation may lower the pH of the composition.

In one embodiment, the dissolved gas can be added to the finished, beverage composition, which contains all of the desired beverage components.

In another embodiment, the dissolved gas is added to a desired volume of water or other suitable liquid to form a water/suitable liquid containing dissolved gas. The water/suitable liquid containing dissolved gas can then be combined with a composition such as a beverage concentrate or beverage syrup to produce the finished beverage composition.

Once the beverage composition has been prepared containing a dissolved gas, it can be packaged in containers and sealed using methods, packaging, and equipment selected by those of ordinary skill in the art without undue experimentation.

In some embodiments, a dissolved gas, specifically carbonation, can be added at the point of consumption. For example, in a restaurant or convenience store, a fountain beverage consisting of a beverage syrup and a source of carbonation is prepared for imminent consumer consumption. In some embodiments, a dissolved gas other than carbon dioxide, such as nitrous oxide, or a combination of nitrous oxide and carbon dioxide can be added at the point of consumption.

One embodiment is a pre-mixed, ready-to-drink foaming beverage, comprising: a foam-creating composition comprising a dairy composition, a hydrocolloid composition, and a foam stabilizer; wherein the foam-creating composition comprises about 2 to about 95 wt % of the dairy composition based on the total weight of the foam-creating composition, and wherein the dairy composition comprises a dairy protein; and wherein the foam-creating composition comprises a ratio of dairy protein to hydrocolloid of about 3:1 wt/wt to about 1:4 wt/wt. In some embodiments, the dairy composition is present in the ready-to-drink beverage in an amount of about 3.0 to about 6.0 wt % based on the total weight of the ready-to-drink beverage. In some embodiments, the hydrocolloid composition is present in the ready-to-drink beverage in an amount of about 0.2 to about 1.5 wt % based on the total weight of the ready-to-drink beverage. In some embodiments, the foam stabilizer is present in the ready-to-drink beverage in an amount of about 0.001 to about 1 wt %, specifically 0.005 to about 0.5 wt %, more specifically 0.01 to 0.2 wt %, based on the total weight of a ready-to-drink beverage.

One embodiment is a pre-mixed, ready-to-drink foaming beverage, comprising: a foam-creating composition comprising a dairy composition, a hydrocolloid composition, and a foam stabilizer; and dissolved gas consisting of a mixture of nitrous oxide and carbon dioxide in a volume/volume ratio of 25:75 to 75:25; wherein the foam-creating composition comprises about 2 to about 95 wt % of the dairy composition based on the total weight of the foam-creating composition, and wherein the dairy composition comprises a dairy protein; wherein the foam-creating composition comprises a ratio of dairy protein to hydrocolloid of about 3:1 wt/wt to about 1:4 wt/wt.

In one embodiment, compositions described herein can contain herbs, minerals, and vitamins that are believed to impart the drinker a boost in energy and an overall enhanced feeling of well-being, referred to as “energy drinks”.

The herbs in the composition may include any one or more of ginkgo biloba, guarana, and ginseng. Ginkgo biloba is known to provide nutritional support for mental alertness, enhanced vitality level, circulatory health and blood vessel health. It also has high antioxidant activity that is valuable for fighting age related conditions. Ginkgo biloba is known to increase blood flow to the brain and throughout the body's network of blood vessels that supply blood and oxygen to the organ systems. It also increases metabolism efficiency, regulates neurotransmitters, and boosts oxygen levels in the brain. Benefits of enhanced circulation in the brain include improved short and long term memory, increased reaction time, and improved mental clarity.

Guarana is a concentrated source of caffeine, and consumption is believed to offer health benefits including stimulating the heart and central nervous system, enhancing alertness, and alleviating fatigue. It also has strong diuretic activity and reduces constriction of the bronchials, aiding the consumer to breathe more freely.

Ginseng is commonly used as an adaptogen, i.e. it normalizes physical functioning depending on what the individual needs (for example, it will lower high blood pressure, but raise low blood pressure). It is also used to reduce the effects of stress, improve performance, boost energy levels, enhance memory, and stimulate the immune system. Ginseng helps maintain body functions, and has been shown to increase energy, stamina, and help the body resist viral infections and environmental toxins.

In a further exemplary embodiment, the composition may include vitamin C, a water-soluble vitamin whose health benefits are well documented as it is vital to the production of collagen by the body. Vitamin C is also important because it helps protect the fat-soluble vitamins A and E as well as fatty acids from oxidation.

In a further exemplary embodiment, the composition may include one or more B vitamins, including thiamine, riboflavin, niacin, pantothenic acid, pyrodixine, biotin, cyanocobalamin, choline and/or folic acid, including the reduced forms of folic acid such as (but not only) folinic acid, calcium folinate, and methyltetrahydrafolate. The B-complex vitamins are also water soluble vitamins that aid the breakdown of carbohydrates into glucose to provide energy for the body, the breakdown of fats and proteins to aid the normal functioning of the nervous system, and muscle tone in the stomach and intestinal tract. Particular forms of B vitamins in the composition may include d-Calcium pantothenate, niacinamide, pyridoxine hydrochloride, and thiamine mononitrate.

The composition may further include inositol, which is known to be necessary for the formation of lecithin and to functions closely with folacin, Vitamins B-6 and B-12, choline, betaine, and methionine to prevent the accumulation of fats in the liver.

Caffeine is known to be useful as a cardiac stimulant and also as a mild diuretic that increases urine production. Of course, caffeine is well known as a mental stimulant, due to its affinity for binding to the adenosine receptors in nerve cells. The caffeine in the composition may include anhydrous caffeine, and may also be provided by the guarana in the composition.

One embodiment is a pre-mixed, ready-to-drink energy beverage, comprising: herbs, minerals, and vitamins that are believed to impart the drinker a boost in energy and an overall enhanced feeling of well-being; and dissolved gas consisting of a mixture of nitrous oxide and carbon dioxide in a volume/volume ratio of 25:75 to 75:25.

The herbs, minerals, and vitamins that are believed to impart the drinker a boost in energy and an overall enhanced feeling of well-being are associated with lingering negative aftertastes or off notes, including bitter, tart, metallic or chemical aftertastes. It is a further object to provide a beverage comprising dissolved gas consisting of a mixture of nitrous oxide and carbon dioxide in a volume/volume ratio of 25:75 to 75:25, wherein the dissolved N₂O in an amount sufficient to reduce the lingering negative aftertaste or off notes associated with herbs, minerals, and vitamins contained in the energy drinks.

One embodiment is a method of preparing a foaming beverage comprises providing a foam-creating composition comprising a dairy composition, a hydrocolloid composition, and a foam stabilizer, wherein the dairy composition comprises a dairy protein; and dispersing the foam-creating composition in an liquid composition to form a beverage; wherein the foam-creating composition comprises a ratio of dairy protein to hydrocolloid of about 3:1 wt/wt to about 1:4 wt/wt.

The foam-creating composition, syrup, concentrate, or beverage composition can further include a sweetening agent to provide a sweet taste to the composition. Sweetening agents may include sugar sweeteners, sugarless sweeteners, and a combination comprising at least one of the foregoing.

Sugar sweeteners generally include saccharides. Suitable sugar sweeteners include mono-saccharides, di-saccharides and poly-saccharides such as sucrose (sugar), dextrose, maltose, dextrin, xylose, ribose, glucose, mannose, galactose, fructose (levulose), lactose, invert sugar, fructooligosaccharide syrups, partially hydrolyzed starch, trehalose, tagatose, sucromalt, corn syrup solids, such as high fructose corn syrup, and a combination comprising at least one of the foregoing.

Suitable sugarless sweetening agents include sugar alcohols (or polyols), such as glycerol, sorbitol, xylitol, mannitol, galactitol, maltitol, hydrogenated isomaltulose (isomalt), lactitol, erythritol, hydrogenated starch hydrolysate, polyglycitol (e.g., syrup or powder), stevia and a combination comprising at least one of the foregoing.

Suitable hydrogenated starch hydrolysates include those disclosed in U.S. Pat. Nos. RE25,959, 4,279,931 and various hydrogenated glucose syrups and/or powders which contain sorbitol, hydrogenated disaccharides, hydrogenated higher polysaccharides, and a combination comprising at least one of the foregoing. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN™, a line of commercially available products manufactured by Roquette Freres of France, and HYSTAR™, a line of commercially available products manufactured by Lonza, Inc., of Fairlawn, N.J., also may be useful.

In some embodiments, the sweetening agent is present in amounts of about 0.01 to about 25 wt % based on the total weight of the composition, specifically about 0.1 to about 15 wt %, more specifically 1.0 to about 10 wt %, and yet more specifically 2.0 to about 5.0 wt % each based on the total weight of the composition. The amount of sweetening agent depends upon whether the composition is a concentrate, syrup, beverage, etc., and can be determined by those of ordinary skill in the art.

Some embodiments may include high-intensity sweeteners in the composition. Without being limited to particular sweeteners, representative categories and examples include:

(a) water-soluble sweetening agents such as dihydrochalcones, monellin, steviosides, rebaudioside A, monatin, lo han quo or derivatives of lo han quo, glycyrrhizin, dihydroflavenol, and sugar alcohols such as sorbitol, mannitol, maltitol, and L-aminodicarboxylic acid aminoalkenoic acid ester amides, such as those disclosed in U.S. Pat. No. 4,619,834, which disclosure is incorporated herein by reference, and a combination comprising at least one of the foregoing;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and a combination comprising at least one of the foregoing;

(c) dipeptide based sweeteners, such as L-aspartic acid derived sweeteners, such as L-aspartyl-L-phenylalanine methyl ester (Aspartame) and materials described in U.S. Pat. No. 3,492,131, L-alpha-aspartyl-N-(2,2,4,4-tetramethyl-3-thietanyl)-D-alaninamide hydrate (Alitame), N-[N-(3,3-dimethylbutyl)-L-aspartyl]-L-phenylalanine 1-methyl ester (Neotame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and a combination comprising at least one of the foregoing;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro 1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro-4,6,1′,6′-tetradeoxygalacto-sucrose; and 4,6,1′,6′-tetradeoxy-sucrose, and a combination comprising at least one of the foregoing;

(e) protein-based sweeteners such as thaumaoccous danielli (Thaumatin I and II); and

(f) the naturally occurring sweetener monatin (2-hydroxy-2-(indol-3-ylmethyl)-4-aminoglutaric acid) and its derivatives, lo han quo and its derivatives.

Many sweetening agents, including some previously discussed, can be categorized as natural sweeteners, for example L-alanine, arabinose, banana extract, carob, cellobiose, corn syrup (including high fructose corn syrup and corn syrup solids), dextrin, dextrose, Dioscoreophyllum cumminsii (Serendipity Berry), erythritol, fructooligosaccharide (FOS), fructose, (including “liquid fructose”), galactose, glucose, glycine, glycyrrhizin, honey, inulin, isomalt, invert sugar, lactitol, lactose, lo han (10 han kuo; lo han guo; lohan guo; lohan kuo), maltitol, maltodextrin, maltose, mannitol, mannose, monatin, maple syrup, molasses, partially hydrogenated starch hydrolysate, partially hydrolyzed starch, polydextrose solution, polyglycitol, raftilose, miraculin (Richadella dulcifica (Miracle Berry)), ribose, rice syrup, sorbitol, sorbose, stevia, stevioside, sucralose, sucrose, sugar beets, (dehydrated filaments of), D-tagatose, thaumatin, xylitol, xylose, sucromalt, and a combination comprising at least one of the foregoing.

The sweetening agent can be used individually or as mixtures.

The sweetening agents can be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and a combination comprising at least one of the foregoing. In general, an effective amount of sweetener can be utilized to provide the level of sweetness desired, and this amount may vary with the sweetener selected. Suitable amounts for each type of sweetener can be selected by one of ordinary skill in the art without undue experimentation.

The foam-creating composition, syrup, concentrate, or beverage composition can further include a flavoring agent.

The term “flavor key” as used herein is a flavor component containing flavoring agents such as flavored oils, and the like, and is typically used to prepare a flavor essence.

The term “flavor essence” (“flavor blend”, “flavor extract”) as used herein is a flavor component generally prepared from a flavor key.

Flavoring agents include those flavors known to one of ordinary skill in the art, such as natural flavors, artificial flavors, spices, seasonings, and the like. Exemplary flavoring agents include synthetic flavor oils and flavoring aromatics and/or oils, oleoresins, essences, distillates, and extracts derived from plants, leaves, flowers, fruits, and so forth, and a combination comprising at least one of the foregoing.

Exemplary flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, prune, raisin, cola, guarana, neroli, pineapple, apricot, banana, melon, apricot, ume, cherry, raspberry, blackberry, tropical fruit, mango, mangosteen, pomegranate, papaya and so forth. Additional exemplary flavors imparted by a flavoring agent include a milk flavor, a butter flavor, a cheese flavor, a cream flavor, and a yogurt flavor; a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamon flavor, a caraway flavor, a cumin flavor, a clove flavor, a pepper flavor, a coriander flavor, a root beer flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bay leaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

In some embodiments, other flavoring agents include aldehydes and esters such as cinnamyl acetate, cinnamaldehyde, citral diethylacetal, dihydrocarvyl acetate, eugenyl formate, p-methylamisol, and so forth can be used. Further examples of aldehyde flavorings include acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), and the like. Generally any flavoring or food additive such as those described in Chemicals Used in Food Processing, publication 1274, pages 63-258, by the National Academy of Sciences, can be used. This publication is incorporated herein by reference.

The flavoring agents can be used in liquid or solid/dried form and can be used individually or in admixture. When employed in dried form, suitable drying means such as spray drying an oil can be used. Alternatively, the flavoring agent is absorbed onto water-soluble materials, such as cellulose, starch, sugar, maltodextrin, gum arabic and so forth or can be encapsulated. In still other embodiments, the flavoring agent is adsorbed onto silicas, zeolites, and the like. The techniques for preparing such dried forms are well known.

In some embodiments, the flavoring agents are used in many distinct physical forms. Without being limited thereto, such physical forms include free forms, such as spray dried, powdered, beaded forms, encapsulated forms, emulsions such as caramel or gum arabic emulsions, and a combination comprising at least one of the foregoing physical forms.

The particular amount of the flavoring agent effective for imparting flavor characteristics to the composition will depend upon several factors including the flavor, the flavor impression, and the like.

Suitable amounts of the flavoring agent can be selected by one of ordinary skill in the art without undue experimentation using guidelines provided. In one embodiment, the flavoring agent can be present in a beverage composition from about 0.1 to about 8.0 wt % based on the total weight of the beverage composition, specifically about 0.4 to about 6 wt %, and more specifically about 1.0 to about 3.0 wt % each based on the total weight of the beverage composition.

The flavoring agent may additionally contain weighting agents, emulsifiers, emulsion stabilizers, antioxidants, liquid vehicles, and the like.

The term “weighting agent” as used herein means any material used to adjust the specific gravity of a material whose specific gravity is lighter or lower than the specific gravity of water. In some embodiments, flavoring agents with specific gravities lower that the specific gravity of water are combined with weighting agents. Without adjusting the specific gravity of such flavoring agents or other materials with specific gravities lower than water, they may rise to the upper surface of the beverage composition. Weighting agents can include, but are not limited to brominated vegetable oil, ester gums, SAIB (sucrose acetate isobutyrate) and a combination comprising at least one of the foregoing.

Other approaches to prevent or delay materials with specific gravities lower than the specific gravity of water from rising to the upper surface of a beverage composition can be to increase the viscosity of the beverage composition or to reduce the particle size of the material with the lower specific gravity. Thus, in some embodiments, flavoring agents without weighting agents remain stable in a beverage composition.

The compositions can also contain, in addition to a flavoring agent, a flavor potentiator. Flavor potentiators are materials that can intensify, supplement, modify or enhance the taste and/or aroma perception of a composition without introducing a characteristic taste and/or aroma perception of their own. In some embodiments, potentiators designed to intensity, supplement, modify, or enhance the perception of flavor, sweetness, tartness, umami, kokumi, saltiness, and a combination comprising at least one of the foregoing.

In some embodiments, examples of suitable potentiators, also known as taste potentiators include neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), sugar acids, potassium chloride, sodium acid sulfate, hydrolyzed vegetable proteins, hydrolyzed animal proteins, yeast extracts, adenosine monophosphate (AMP), glutathione, nucleotides, such as inosine monophosphate, disodium inosinate, xanthosine monophosphate, guanylate monophosphate, alapyridaine (N-(1-carboxyethyl)-6-(hydroxymethyppyridinium-3-ol inner salt), sugar beet extract (alcoholic extract), sugarcane leaf essence (alcoholic extract), curculin, strogin, mabinlin, gymnemic acid, hydroxybenzoic acids, 3-hydrobenzoic acid, 2,4-dihydrobenzoic acid, citrus aurantium, vanilla oleoresin, sugarcane leaf essence, maltol, ethyl maltol, vanillin, licorice glycyrrhizinates, compounds that respond to G-protein coupled receptors (T2Rs and T1Rs), G-protein coupled receptors (T2Rs and T1Rs), and taste potentiator compositions that impart kokumi, as disclosed in U.S. Pat. No. 5,679,397 to Kuroda et al., which is incorporated in its entirety herein by reference, and a combination comprising at least one of the foregoing potentiators. “Kokumi” refers to materials that impart “mouthfulness” and “good body”.

Sweetener potentiators, which are a type of taste potentiator, enhance the taste of sweetness. In some embodiments, exemplary sweetener potentiators include, monoammonium glycyrrhizinate, licorice glycyrrhizinates, citrus aurantium, alapyridaine, alapyridaine (N-(1-carboxyethyl)-6-(hydroxymethyppyridinium-3-ol) inner salt, miraculin, curculin, strogin, mabinlin, gymnemic acid, cynarin, glupyridaine, pyridinium-betain compounds, sugar beet extract, neotame, thaumatin, neohesperidin dihydrochalcone, hydroxybenzoic acids, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs), G-protein coupled receptors (T2Rs and T1Rs), and a combination comprising at least one of the foregoing potentiators.

Additional examples of potentiators for the enhancement of salt taste include acidic peptides, such as those disclosed in U.S. Pat. No. 6,974,597, herein incorporated by reference. Acidic peptides include peptides having a larger number of acidic amino acids, such as aspartic acid and glutamic acid, than basic amino acids, such as lysine, arginine and histidine. The acidic peptides are obtained by peptide synthesis or by subjecting proteins to hydrolysis using endopeptidase, and if necessary, to deamidation. Suitable proteins for use in the production of the acidic peptides or the peptides obtained by subjecting a protein to hydrolysis and deamidation include plant proteins, (e.g. wheat gluten, corn protein (e.g., zein and gluten meal), soybean protein isolate), animal proteins (e.g., milk proteins such as milk casein and milk whey protein, muscle proteins such as meat protein and fish meat protein, egg white protein and collagen), and microbial proteins (e.g., microbial cell protein and polypeptides produced by microorganisms).

In some embodiments, the foam-creating composition, concentrate, syrup, or beverage composition can include optional additives such as antioxidants, amino acids, caffeine, coloring agents (“colorants”, “colorings”), emulsifiers, flavor potentiators, food-grade acids, minerals, micronutrients, plant extracts, phytochemicals (“phytonutrients”), preservatives, salts including buffering salts, stabilizers, medicaments, vitamins, and a combination comprising at least one of the foregoing additives. Those of ordinary skill in the art will appreciate that certain additives may meet the definition or function according to more than one of the above-listed additive categories.

The compositions described herein may optionally comprise a salt. Suitable salts include, for example, alkali or alkaline earth metal chlorides, glutamates, and the like. For example, monosodium glutamate, potassium chloride, sodium chloride, and a combination comprising at least one of the foregoing salts. The salts can be added to a beverage as a flavor potentiator as previously described.

The term “food-grade acid,” as used herein, encompasses any acid that is acceptable for use in edible compositions.

The compositions may optionally further contain a food-grade acid. Suitable food-grade acids for use in the composition include, for example, acetic acid, adipic acid, ascorbic acid, butyric acid, citric acid, formic acid, fumaric acid, glyconic acid, lactic acid, malic acid, phosphoric acid, oxalic acid, succinic acid, tartaric acid, and a combination comprising at least one of the foregoing food-grade acids. The food-grade acid can be added as acidulant to control the pH of the beverage and also to provide some preservative properties, or to stabilize the beverage.

The foam-creating composition may contain an amount of food-grade acid of about 0.06 to about 1.0 wt % based on the total weight of the foam-creating composition, specifically about 0.1 to about 0.8 wt % In some embodiments, the ready-to-drink beverage comprises about 0.06 to about 0.6 wt % food-grade acid, based on the total weight of the beverage.

The pH of the beverage may also be modified by the addition of food-grade compounds such as ammonium hydroxide, sodium carbonate, potassium carbonate, sodium bicarbonate, and the like, and a combination comprising at least one of the foregoing. Additionally, the pH of the beverage can be adjusted by the addition of carbon dioxide. Further, in some embodiments, buffering agents including, but not limited to citrates such as sodium citrate, can be used to adjust the pH of the beverage.

In some embodiments, the tartness of the composition may be varied by selecting and combining acids to provide a desired tartness perception.

Some factors to consider in determining a desired tartness include, for example, the acid's dissociation constant, solubility, pH, etc. These variables can be measured by measuring the titratable acidity of the beverage composition. Tartness can also be measures by standard sensory science techniques such as those described by H. Moskowitz in Sourness of Acid Mixtures as published in The Journal of Experimental Psychology, April 1974; 102(4); 640-7 and in Ration Scales of Acid Sourness as published in Perception and Psychophysics; 9:371-374, 1971.

Coloring agents can be used in amounts effective to produce a desired color for the composition. The colorants may include pigments, natural food colors and dyes suitable for food, drug and cosmetic applications. A full recitation of all F.D.& C. colorants and their corresponding chemical structures can be found in the Kirk-Othmer Encyclopedia of Chemical Technology, 3rd Edition, in volume 5 at pages 857-884, of which text is incorporated herein by reference.

As classified by the United States Food, Drug, and Cosmetic Act (21 C.F.R. 73), colors can include exempt from certification colors (sometimes referred to as natural even though they can be synthetically manufactured) and certified colors (sometimes referred to as artificial), and a combination comprising at least one of the foregoing. In some embodiments, exemplary exempt from certification or natural colors can include, annatto extract, (E160b), bixin, norbixin, astaxanthin, dehydrated beets (beet powder), beetroot red/betanin (E162), ultramarine blue, caramel color (E 150a), canthaxanthin (E161g), cryptoxanthin (E161c), rubixanthin (E161d), violanxanthin (E161e), rhodoxanthin (E161f), caramel (E 150(a-d)), .beta.-apo-8′-carotenal (E160e), .beta.-carotene (E160a), alpha carotene, gamma carotene, ethyl ester of beta-apo-8 carotenal (E160f), flavoxanthin (E161a), lutein (E161b), cochineal extract (E120); carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), and a combination comprising at least one of the foregoing.

In some embodiments, exemplary certified colors can include FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E1 27), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), and a combination comprising at least one of the foregoing. In some embodiments, certified colors can include FD&C aluminum lakes. These consist of the aluminum salts of FD&C dyes extended on an insoluble substrate of alumina hydrate. Additionally, in some embodiments, certified colors can be included as calcium salts.

Acceptable coloring agents are specifically water-soluble coloring agents.

Suitable amounts of colorant to provide the desired visual effect can be selected by one of ordinary skill in the art without undue experimentation using guidelines provided. Exemplary amounts of coloring agents can be about 0.005 to about 15 wt %, specifically about 0.01 to about 6 wt %, and more specifically about 0.1 to about 2 wt % each based on the total weight of the composition.

Emulsifiers can be added to the composition to prevent separation of the composition components by keeping ingredients dispersed. Emulsifiers can include molecules that have both a hydrophilic part and a hydrophobic part. Emulsifiers can operate at the interface between hydrophilic and hydrophobic materials of the beverage to prevent separation of the components of the composition. Suitable emulsifiers for use in the compositions include, for example, lecithin (e.g., soy lecithin); mono and di-glycerides of long chain fatty acids, specifically saturated fatty acids, and more specifically, stearic and palmitic acid mono- and diglycerides; mono and di-glycerides of acetic acid, citric acid, tartaric acid, or lactic acid; egg yolks; polysorbates (e.g., polysorbate 20, polysorbate 40, polysorbate 60, polysorbate 65, and polysorbate 80), propylene glycol esters (e.g., propylene glycol monostearate); propylene glycol esters of fatty acids; sorbitan esters (e.g., sorbitan monostearates, sorbitan tristearates, sorbitan monolaurate, sorbitan monooleate), sucrose monoesters; polyglycerol esters; polyethoxylated glycerols; and the like, and a combination comprising at least one of the foregoing emulsifiers.

The composition can contain the emulsifier in an amount of about 0.01 to about 2.0, specifically about 0.05 to about 1.0, more specifically about 0.075 to about 0.75; and yet more specifically about 0.10 to about 0.50 wt % each based on the total weight of the composition.

Preservatives, including antimicrobials, can be added to the composition to provide freshness and to prevent the unwanted growth of bacteria, molds, fungi, or yeast. The addition of a preservative, including antioxidants, may also be used to maintain the composition's color, flavor, or texture. Any suitable preservatives for use in food and beverage products can be incorporated into the compositions. Examples of suitable preservatives include benzoic acid alkali metal salts (e.g., sodium benzoate), sorbic acid alkali metal salts (e.g., potassium sorbate), ascorbic acid (Vitamin C), citric acid, calcium propionate, sodium erythorbate, sodium nitrite, calcium sorbate, butylated hydroxyanisole (BHA), butylated hydroxytoluene (BHT), ethylenediaminetetraacetic acid (EDTA), tocopherols (Vitamin E), straight chain polyphosphates, and a combination comprising at least one of the foregoing preservatives.

The composition can contain the preservative or preservative combination in an amount of about 0.01 to about 0.50, specifically about 0.02 to about 0.30, more specifically about 0.03 to about 0.10; and yet more specifically about 0.05 to about 0.08 wt % each based on the total weight of the composition.

The composition can be fortified or enriched with vitamins, minerals, micronutrients, or other nutrients. Micronutrients can include materials that have an impact on the nutritional well being of an organism even though the quantity required by the organism to have the desired effect is small relative to macronutrients, such as protein, carbohydrate, and fat. Micronutrients can include, for example, vitamins, minerals, enzymes, phytochemicals, antioxidants, and a combination comprising at least one of the foregoing.

Suitable vitamins or vitamin precursors include ascorbic acid (Vitamin C), beta carotene, niacin (Vitamin B₃), riboflavin (Vitamin B₂), thiamin (Vitamin B₁), niacinamide, folate or folic acid, alpha tocopherols or esters thereof, Vitamin D, retinyl acetate, retinyl palmitate, pyridoxine (Vitamin B₆), folic acid (Vitamin B₉), cyanocobalimin (Vitamin B₁₂), pantothenic acid, biotin, and a combination comprising at least one of the foregoing vitamins.

In some embodiments, vitamins or vitamin precursors can include fat soluble vitamins such as vitamin A, vitamin D, vitamin E, and vitamin K, and a combination comprising at least one of the foregoing vitamins. In some embodiments, vitamins or vitamin precursors can include water soluble vitamins such as vitamin C (ascorbic acid), the B vitamins (thiamine or B₁, riboflavin or B₂, niacin or B₃, pyridoxine or B₆, folic acid or B₉, cyanocobalimin or B₁₂, pantothenic acid, biotin), and a combination comprising at least one of the foregoing vitamins.

Exemplary minerals include sodium, magnesium, chromium, iodine, iron, manganese, calcium, copper, fluoride, potassium, phosphorous, molybdenum, selenium, zinc, and a combination comprising at least one of the foregoing minerals. The minerals can be provided as a mineral salt, including carbonate, oxide, hydroxide, chloride, sulfate, phosphate, pyrophosphate, gluconate, lactate, acetate, fumarate, citrate, malate, amino acids and the like for the cationic minerals and sodium, potassium, calcium, magnesium and the like for the anionic minerals.

The amount of vitamins or minerals provided in the compositions can be up to or exceeding amounts generally recognized as U.S. Recommended Daily amounts or the Recommended Daily Intake amounts established by the U.S. Food and Drug Administration.

In some embodiments exemplary micronutrients can include L-carnitine, choline, coenzyme Q10, alpha-lipoic acid, omega-3-fatty acids, pepsin, phytase, trypsin, lipases, proteases, cellulases, and a combination comprising at least one of the foregoing micronutrients.

Antioxidants can include materials that scavenge free radicals. In some embodiments, exemplary antioxidants can include citric acid, rosemary oil, vitamin A, vitamin E, vitamin E phosphate, tocopherols, di-alpha-tocopheryl phosphate, tocotrienols, alpha lipoic acid, dihydrolipoic acid, xanthophylls, beta cryptoxanthin, lycopene, lutein, zeaxanthin, astaxanthin, beta-carotene, carotenes, mixed carotenoids, polyphenols, flavonoids, and a combination comprising at least one of the foregoing antioxidants.

Exemplary nutrients can also include amino acids such as L-tryptophan, L-lysine, L-leucine, L-methionine, 2-aminoethanesulfonic acid (taurine), and L-carnitine; creatine; glucuronolactone; inositol; and a combination comprising at least one of the foregoing nutrients.

Phytochemicals (“phytonutrients”) are plant derived compounds which may provide a beneficial effect on the health or well-being of the consumer. Phytochemicals include plant derived antioxidants, phenolic compounds including monophenols and polyphenols, and the like. Exemplary phytochemicals include lutein, lycopene, carotene, anthocyanin, capsaicinoids, flavonoids, hydroxycinnamic acids, isoflavones, isothiocyanates, monoterpenes, chalcones, coumestans, dihydroflavonols, flavanoids, flavanols, quercetin, flavanones, flavones, flavan-3-ols (catechins, epicatechin, epigallocatechin, epigallocatechingallate, and the like), flavonals (anthocyanins, cyanidine, and the like); phenolic acids; phytosterols, saponins, terpenes (carotenoids), and a combination comprising at least one of the foregoing phytochemicals.

The phytochemicals can be provided in substantially pure or isolated form or in the form of natural plant extracts. Suitable plant extracts which contain one or more phytochemicals include fruit skin extracts (grape, apple, crab apple, and the like), green tea extracts, white tea extracts, green coffee extract, and a combination comprising at least one of the foregoing extracts.

Various herbals, aromatic plants or plant parts or extracts thereof, can also be included in the compositions for a variety of reasons such as for flavor or for their potential health benefits. Exemplary herbals include Echinacea, Goldenseal, Calendula, Rosemary, Thyme, Kava Kava, Aloe, Blood Root, Grapefruit Seed Extract, Black Cohosh, Ginseng, Guarana, Cranberry, Ginko Biloba, St. John's Wort, Evening Primrose Oil, Yohimbe Bark, Green Tea, Ma Huang, Maca, Bilberry, extracts thereof, and a combination comprising at least one of the foregoing herbals.

l In some embodiments, the beverage composition is subject to homogenization conditions, such as high pressure homogenization, to provide a homogenous beverage composition. Any conventional homogenization equipment can be employed, such as equipment available from APV Gaulin, Alfa-Laval or Niro Soavi.

In some embodiments, the beverage composition is pasteurized to sterilize the product by destroying unwanted microorganisms. Exemplary processes to destroy or remove unwanted microorganisms include hot-filling, aseptic packaging, ozonation, radiation (e.g., ultraviolet light or gamma rays), membrane permeation, pulsed electric field, sonication, and the like.

Depending upon the components of the beverage composition, pasteurization can be effected at different temperatures. For dairy, grain, fruit or vegetable-based beverage compositions a pasteurization temperature of about 60 to about 80° C. can be sufficient, specifically about 65 to about 75° C., and more specifically about 68 to about 72° C. More specifically, the fruit or vegetable-based beverage composition can be pasteurized by heating to the desired temperature for about 6 about 15 minutes in an aseptic environment, more specifically about 8 about 12 minutes, and yet more specifically about 9 about 11 minutes.

The beverage composition can be bulk pasteurized and then filled into a desired beverage container. In some embodiments, the beverage composition is filled into the desired beverage container, such as a glass bottle, and then subjected to the pasteurization conditions.

Alternatively, in some embodiments, the beverage composition is hot-filled into the desired beverage container. More specifically, the beverage composition is filled into the beverage container at temperatures sufficient to sterilize the composition in the container, for example about 85° C. After several minutes, the container and composition can be cooled down to about 32 to about 38° C.

In other embodiments, the beverage composition, containing prepasteurized foam-creating composition, is cold-filled into a desired beverage container. In such embodiments, preservatives can be added to the beverage composition. More specifically, cold-filling the beverage involves adding the beverage to the beverage container at ambient temperature (e.g., about 21° C.). Preservatives, such as those described herein, can be added to the composition to lower the pH level of the composition. Desirable pH values can be about 3 to about 4.5. In some embodiments, the pH is about 4 or less, specifically about 2 or less. Cold-filling with preservatives is used in some embodiments as an alternative to pasteurization.

In some embodiments, aseptic processes can be used to provide shelf stable, sterile beverages without the use of preservatives. The aseptic process involves sterilizing the beverage composition using an ultra-high temperature process that rapidly heats, then cools, the beverage composition. The time for sterilization can be about 3 to about 15 seconds at temperatures of about 195° F. (90.6° C.) to about 285° F. (140.6° C.). The sterilized beverage composition is then filled into sterilized aseptic packages within a sterile environment. Exemplary aseptic packages include a laminated container prepared from paperboard, polyethylene, e.g., low-density polyethylene (innermost layer), and aluminum; high density polyethylene (HDPE) plastic bottles; and the like.

The beverage compositions can be packaged in a container as ready-to-drink, shelf stable beverage products. Any type of beverage container can be used to package the beverage composition including glass bottles, plastic bottles and containers (e.g., polyethylene terephthalate or foil lined ethylene vinyl alcohol), metal cans (e.g., coated aluminum or steel), lined cardboard containers, and the like. Other beverage packaging material known to one of ordinary skill in the art can be used.

In one embodiment, the packaged beverage can include a foam-creating device to further froth the beverage upon opening the beverage container. The use of the device would allow for the formation of a frothy foam head on the beverage without the need for the consumer to shake the container prior to opening. Such devices are known in the art, typically for beer or beer-related beverages, and especially those beverages containing sufficient amounts of dissolved gasses. These devices can comprise containers with distinct chambers, foam-creating features, devices at the container opening, container inserts that function to introduce a stream of gas to the surface of the beverage in the container, features to create a nucleation site in the container to allow for dissolved gases to escape from the beverage, and the like. Exemplary containers and devices can be found in U.S. Pat. Nos. 4,279,938, 4,832,968, 5,009,901, 5,290,574, 5,334,400, 5,660,867, 5,714,186, 5,827,555, 5,980,959, and 6,896,920; and WO2004/054896.

Beverages prepared from the foam-creating composition disclosed herein provide a thick, creamy head of foam when the beverage is shaken and then poured. The step of shaking or agitating the beverage prior to pouring can be omitted if the beverage is prepared with dissolved gas, such as carbonation, as the release of the gas provides sufficient agitation to result in a foam head. The foam formation can be enhanced with the use of a foam-creating device as discussed above.

Beverages prepared from the foam-creating composition and further having dissolved gas retain the dissolved gas longer than similar beverages that do not contain the foam-creating composition. In one embodiment, the amount of dissolved gas present in a beverage prepared from the foam-creating composition changes by less than about 25% when comparing the amount of dissolved gas in the beverage freshly poured at an initial temperature of 5° C. to the amount of dissolved gas in the beverage after resting at 20° C. for 1 hour post pouring.

Additionally, beverages prepared from the foam-creating composition provide a longer retention of foam head as compared to beverages that do not contain the foam-creating composition or even beverages containing only known foam enhancers such as yucca. In some embodiments, pouring the beverage at 40-50° F. (4.4-10° C.) into an open container and waiting three minutes after transfer of the beverage to the container produces a liquid phase and a foam phase, wherein a ratio of the foam phase volume to the liquid phase volume is about 0.1:1 to about 1:1, specifically about 0.2:1 to about 0.5:1. A procedure for determining the ratio of foam phase volume to liquid phase volume is provided in the working examples below.

In one embodiment, a method of stabilizing foam in a beverage comprises preparing a beverage composition, a bottling syrup, a fountain syrup, or a beverage concentrate to comprise an amount of a foam-creating composition to stabilize a foam in a beverage, wherein the foam-creating composition comprises a dairy composition, a hydrocolloid composition, and a foam stabilizer, wherein the dairy composition comprises a dairy protein; and wherein the foam-creating composition comprises a ratio of dairy protein to hydrocolloid of about 3:1 wt/wt to about 1:4 wt/wt.

In one embodiment, a method of creating foam in a beverage comprises preparing a beverage composition comprising an amount of a foam-creating composition; optionally shaking the beverage composition; and dispensing the beverage to form a foam; wherein the foam-creating composition comprises a dairy composition, a hydrocolloid composition, and a foam stabilizer, wherein the dairy composition comprises a dairy protein; and wherein the foam-creating composition comprises a ratio of dairy protein to hydrocolloid of about 3:1 wt/wt to about 1:4 wt/wt.

In one embodiment, kits can be provided containing the foam-creating compositions or beverage compositions described herein along with a communication that the composition creates foam. In specific embodiments, the communication informs the consumer that dispensing the composition creates foam; or shaking and dispensing the composition creates foam. The communication can be in any format that can communicate the foam creating property of the compositions. Exemplary forms of communication include printed matter (e.g., as an advertisement, product literature, flyer, label, container, etc.).

In one embodiment, a kit comprises a foam-creating composition comprising about 2 to about 95 wt % dairy composition based on the total weight of the foam-creating composition, wherein the dairy composition comprises a dairy protein; a hydrocolloid composition; and a foam stabilizer; wherein the foam-creating composition comprises a ratio of dairy protein to hydrocolloid of about 3:1 wt/wt to about 1:4 wt/wt.; and communication that use of the composition creates foam.

In another embodiment, a kit comprises a pre-mixed, ready-to-drink foaming beverage comprising a foam-creating composition comprising a dairy composition, a hydrocolloid composition, and a foam stabilizer; wherein the foam-creating composition comprises about 2 to about 95 wt % of the dairy composition based on the total weight of the foam-creating composition, and wherein the dairy composition comprises a dairy protein; and wherein the foam-creating composition comprises a ratio of dairy protein to hydrocolloid of about 3:1 wt/wt to about 1:4 wt/wt; and communication that dispensing the composition creates foam.

The features and advantages are more fully shown by the following examples, which are provided for purposes of illustration, and are not to be construed as limiting the invention in any way.

### EXAMPLES

### Example 1

### Foam-Creating Composition

TABLE 1

| Component | % wt/wt |
|---|---|
| Skim milk (~7.5% protein) | 67.78 |
| Cream (~1.67% protein) | 14.44 |
| Water | 7.78 |
| Phosphoric Acid | 0.56 |
| Pectin | 0.56 |
| Propylene Glycol Alginate | 4.44 |
| Gum Arabic | 4.44 |

The components provided in Table 1 are combined to form a uniform mixture containing about 5.32 wt % dairy protein and about 9.44 wt % total hydrocolloid to result in a foam-creating composition having a dairy protein to total hydrocolloid ratio of about 1:1.77.

The foam creation/stabilization composition can be used to prepare a beverage by the addition of water, juice, milk, a chocolate flavored ingredient etc. with stirring. The resulting beverage can be packaged in a beverage container, where the beverage forms a foamy head when shaken and poured. If the beverage is carbonated or contains dissolved gas under pressure, the shaking step may be omitted.

### Example 2

### Ready-to-Drink, Foaming Beverage

TABLE 2

| Component | % wt/wt |
|---|---|
| Water | 83.050 |
| Sugar | 12.400 |
| Skim milk | 3.050 |
| Cream | 0.650 |
| Pectin | 0.225 |
| Propylene Glycol Alginate | 0.200 |
| Gum Arabic | 0.200 |
| Citric Acid | 0.200 |
| Phosphoric Acid | 0.050 |
| Flavor | q.s. |

A ready-to-drink, foaming beverage is prepared from the components of Table 2. The pectin, propylene glycol alginate, and gum arabic are dry-blended together with sugar to form a dry blend. The dry blend is then added to one-fifth the quantity of water with mixing. The remaining ingredients are added in the order shown in Table 2 to form a mixture. The remaining quantity of water is carbonated to 2.0 volumes of CO₂ and the mixture is added to the carbonated water to form the final beverage. The final can be packaged in a beverage container to form a ready-to-drink beverage product.

### Example 3

### Beverage Foam Stabilization

The beverage of Example 2 is tested for foam stabilization. Fifty milliliter aliquots each of the beverage of Example 2 and a comparative example beverage having no pectin, propylene glycol or gum Arabic are separately shaken for an equivalent time and rate. Both beverages are refrigerated at 5° C. overnight prior to the test. The shaken beverages are each poured into a separate standard 100 ml graduated cylinder and the volume of the foam is determined. After the beverages are allowed to remain at room temperature (˜20° C.) for one hour, the volume of the foam is again measured. The beverage of Example 2 provides a significant retention of foam volume as compared to the comparative example.

### Example 4

### Ready-to-Drink, Foaming Beverage with CO₂ and N₂O

The beverage of Example 2 is prepared with a 50:50 combination of carbon dioxide and nitrous oxide. It was unexpectedly found that the foam volume of the resulting beverage is retained significantly longer than the foam volume retained for the beverage of Example 2.

### Examples 5-124

### Measurement of Foam Phase Volume and Liquid Phase Volume

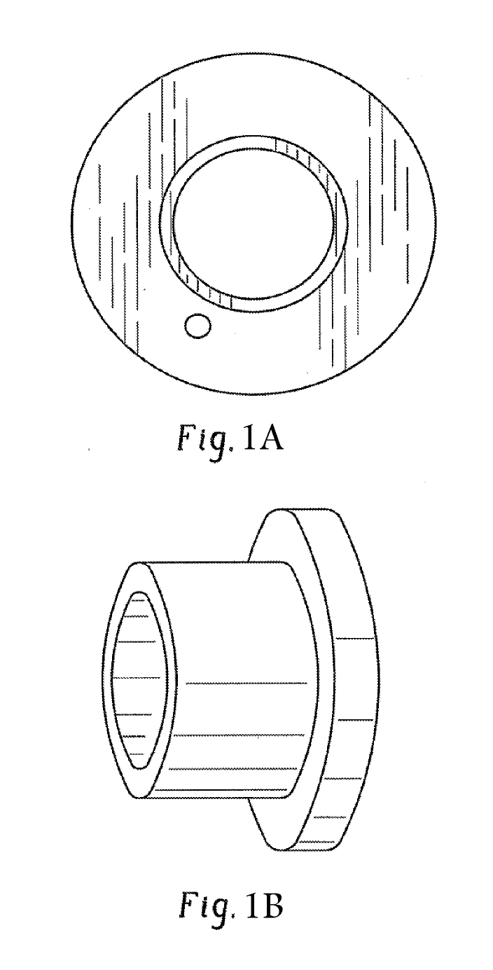

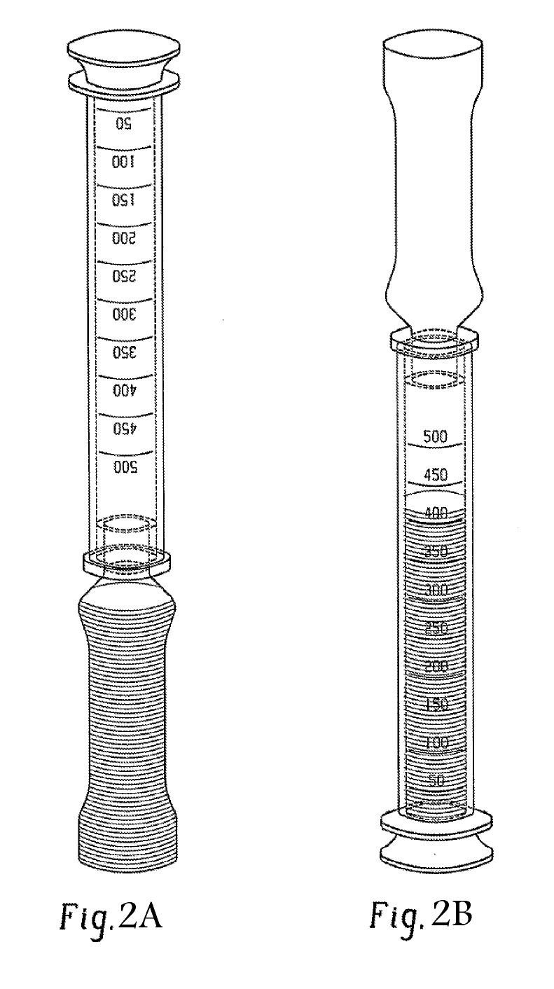

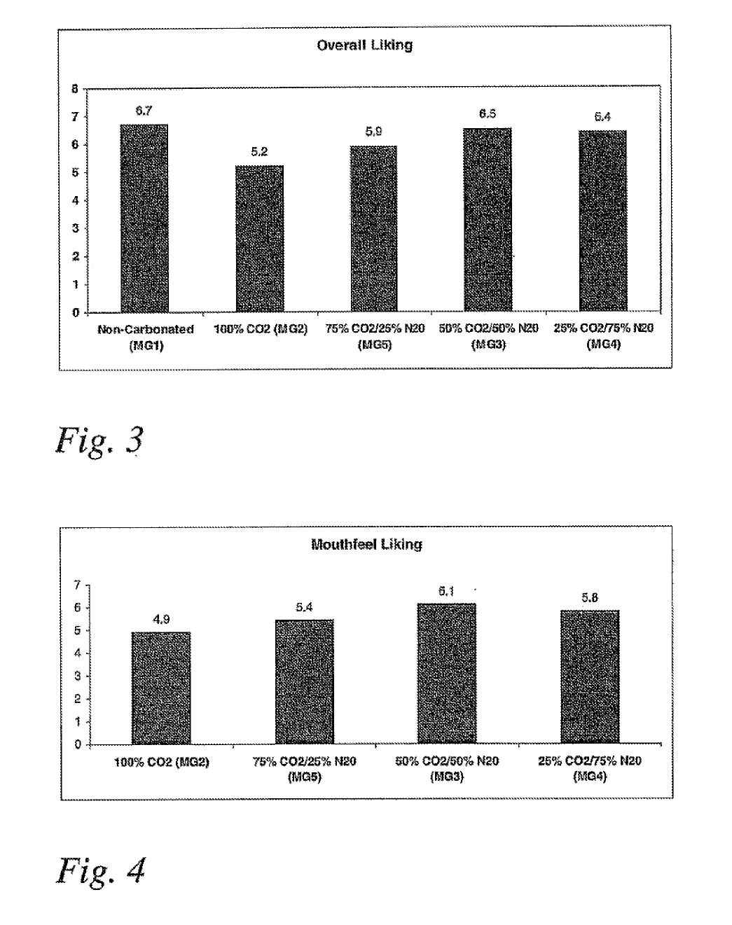

This example illustrates the determination of foam phase volume and liquid phase volume for a freshly poured beverage. A bottle containing about 349-355 milliliters (10.8-12.0 U.S. fluid ounces) of beverage and 2.5 volumes of dissolved gas was cooled to a predetermined temperature of 40 or 50° F. (4.4 or 10.0° C.). A 500 milliliter graduated cylinder was cleaned, rinsed, and dried, then fitted with an adapter to accommodate the beverage bottle. The adapter supports the beverage bottle on graduated cylinder and allows the pressure within the apparatus to equalize with ambient pressure (about one atmosphere). Images corresponding to two views of the adapter are provided as FIGS. 1(a) and (b). The graduated cylinder with adapter was then inverted and placed on the neck of the beverage bottle. A count-down timer was set to three minutes. The bottle and graduated cylinder, joined by the adapter, were then inverted and set on a flat surface so that the contents of the bottle flowed down vertically into the graduated cylinder. After the entire contents of the bottle had emptied into the graduated cylinder (a process that took about 6 to 8 seconds), the timer was started. At the end of a three-minute period, the volume levels, in milliliters, of the liquid/foam interface and the foam/air interface were read on the graduated cylinder. Images of the apparatus before and after transfer of a representative beverage sample from the bottle to the graduated cylinder are shown in FIGS. 2(a) and (b), respectively. The liquid volume corresponded to the reading for the liquid/foam interface. The foam volume corresponded to the difference between reading for the foam/air interface and the reading for the liquid/foam interface. For example, if the reading for the liquid/foam interface was 330 milliliters, and the reading for the foam/air interface was 400 milliliters, then the liquid volume was 330 milliliters, the foam volume was 400−330=70 milliliters, and the ratio of foam volume to liquid volume was 70:330, or 1:4.71.

This procedure was conducted for ready-to-drink beverages having the composition of Example 2 above and additionally containing 2.5 volumes of dissolved gas. The initial temperature of the beverage and the volume ratio of carbon dioxide (CO₂) and nitrous oxide (N₂O) in the gas were varied. Twelve samples were tested for each combination of temperature and gas composition. Results are presented in Table 3. Averages and standard deviations for each condition are presented in Table 4.

The results demonstrate the ability of combinations of carbon dioxide and nitrous oxide to provide a stable foam across a range of blends. This allows formulation flexibility to adapt the gas blend for reasons such as cost.

TABLE 3
Phase Volumes as a Function of Temperature and Dissolved Gas
Composition

| | | | Foam | Liquid | |
|---|---|---|---|---|---|
| Ex. | Temp. | N₂O: | Volume | Volume | Foam Volume: |
| No. | (° F.) | CO₂ | (mL) | (mL) | Liquid Volume |
| 5 | 41.2 | 25:75 | 155 | 290 | 0.534 |
| 6 | 41.5 | 25:75 | 230 | 255 | 0.902 |
| 7 | 40.5 | 25:75 | 165 | 270 | 0.611 |
| 8 | 39.3 | 25:75 | 170 | 280 | 0.607 |
| 9 | 39.5 | 25:75 | 120 | 285 | 0.421 |
| 10 | 39.5 | 25:75 | 110 | 305 | 0.361 |
| 11 | 39.1 | 25:75 | 205 | 265 | 0.774 |
| 12 | 40.1 | 25:75 | 255 | 235 | 1.085 |
| 13 | 39.9 | 25:75 | 145 | 290 | 0.500 |
| 14 | 39.4 | 25:75 | 100 | 305 | 0.328 |
| 15 | 39.5 | 25:75 | 230 | 255 | 0.902 |
| 16 | 39.8 | 25:75 | 180 | 275 | 0.655 |
| 17 | 50.2 | 25:75 | 210 | 265 | 0.792 |
| 18 | 50.2 | 25:75 | 200 | 255 | 0.784 |
| 19 | 50.3 | 25:75 | 205 | 270 | 0.759 |
| 20 | 50.3 | 25:75 | 240 | 255 | 0.941 |
| 21 | 50.2 | 25:75 | 200 | 265 | 0.755 |
| 22 | 50.2 | 25:75 | 245 | 255 | 0.961 |
| 23 | 50.2 | 25:75 | 265 | 235 | 1.128 |
| 24 | 50.1 | 25:75 | 175 | 275 | 0.636 |
| 25 | 50.2 | 25:75 | 255 | 245 | 1.041 |
| 26 | 49.9 | 25:75 | 320 | 230 | 1.391 |
| 27 | 49.8 | 25:75 | 255 | 245 | 1.041 |
| 28 | 50.0 | 25:75 | 250 | 250 | 1.000 |
| 29 | 40.8 | 40:60 | 240 | 230 | 1.043 |
| 30 | 41.0 | 40:60 | 215 | 245 | 0.878 |
| 31 | 40.4 | 40:60 | 220 | 240 | 0.917 |
| 32 | 40.3 | 40:60 | 150 | 270 | 0.556 |
| 33 | 40.4 | 40:60 | 125 | 280 | 0.446 |
| 34 | 40.3 | 40:60 | 235 | 230 | 1.022 |
| 35 | 41.1 | 40:60 | 220 | 245 | 0.898 |
| 36 | 40.5 | 40:60 | 260 | 215 | 1.209 |
| 37 | 40.5 | 40:60 | 125 | 275 | 0.455 |
| 38 | 40.9 | 40:60 | 225 | 225 | 1.000 |
| 39 | 40.5 | 40:60 | 215 | 245 | 0.878 |
| 40 | 41.3 | 40:60 | 185 | 255 | 0.725 |
| 41 | 50.7 | 40:60 | 310 | 215 | 1.442 |
| 42 | 50.0 | 40:60 | 405 | 170 | 2.382 |
| 43 | 50.0 | 40:60 | 245 | 235 | 1.043 |
| 44 | 50.0 | 40:60 | 280 | 215 | 1.302 |
| 45 | 49.8 | 40:60 | 260 | 230 | 1.130 |
| 46 | 50.0 | 40:60 | 275 | 225 | 1.222 |
| 47 | 50.1 | 40:60 | 305 | 215 | 1.419 |
| 48 | 49.8 | 40:60 | 340 | 210 | 1.619 |
| 49 | 49.8 | 40:60 | 300 | 215 | 1.395 |
| 50 | 49.8 | 40:60 | 370 | 180 | 2.056 |
| 51 | 49.6 | 40:60 | 310 | 210 | 1.476 |
| 52 | 50.4 | 40:60 | 350 | 200 | 1.750 |
| 53 | 42.0 | 50:50 | 215 | 235 | 0.915 |
| 54 | 42.0 | 50:50 | 220 | 235 | 0.936 |
| 55 | 40.4 | 50:50 | 185 | 250 | 0.740 |
| 56 | 40.3 | 50:50 | 205 | 245 | 0.837 |
| 57 | 40.4 | 50:50 | 180 | 255 | 0.706 |
| 58 | 40.3 | 50:50 | 225 | 235 | 0.957 |
| 59 | 40.1 | 50:50 | 200 | 255 | 0.784 |
| 60 | 40.0 | 50:50 | 270 | 215 | 1.256 |
| 61 | 40.0 | 50:50 | 150 | 260 | 0.577 |
| 62 | 39.7 | 50:50 | 230 | 230 | 1.000 |
| 63 | 39.9 | 50:50 | 270 | 215 | 1.256 |
| 64 | 40.0 | 50:50 | 245 | 230 | 1.065 |
| 65 | 50.0 | 50:50 | 380 | 195 | 1.949 |
| 66 | 49.9 | 50:50 | 370 | 190 | 1.947 |
| 67 | 50.0 | 50:50 | 450 | 165 | 2.727 |
| 68 | 49.9 | 50:50 | 365 | 195 | 1.872 |
| 69 | 50.0 | 50:50 | 420 | 170 | 2.471 |
| 70 | 49.9 | 50:50 | 420 | 180 | 2.333 |
| 71 | 49.8 | 50:50 | 350 | 200 | 1.750 |
| 72 | 49.6 | 50:50 | 335 | 205 | 1.634 |
| 73 | 49.6 | 50:50 | 435 | 165 | 2.636 |
| 74 | 49.9 | 50:50 | 360 | 190 | 1.895 |
| 75 | 49.6 | 50:50 | 350 | 200 | 1.750 |
| 76 | 49.8 | 50:50 | 330 | 200 | 1.650 |
| 77 | 40.8 | 60:40 | 375 | 175 | 2.143 |
| 78 | 40.6 | 60:40 | 400 | 175 | 2.286 |
| 79 | 40.9 | 60:40 | 375 | 175 | 2.143 |
| 80 | 40.4 | 60:40 | 360 | 175 | 2.057 |
| 81 | 39.6 | 60:40 | 360 | 175 | 2.057 |
| 82 | 39.6 | 60:40 | 365 | 170 | 2.147 |
| 83 | 40.0 | 60:40 | 295 | 205 | 1.439 |
| 84 | 39.6 | 60:40 | 370 | 165 | 2.242 |
| 85 | 39.8 | 60:40 | 380 | 170 | 2.235 |
| 86 | 39.5 | 60:40 | 345 | 180 | 1.917 |
| 87 | 39.8 | 60:40 | 375 | 175 | 2.143 |
| 88 | 40.0 | 60:40 | 380 | 170 | 2.235 |
| 89 | 50.7 | 60:40 | 375 | 175 | 2.143 |
| 90 | 50.5 | 60:40 | 375 | 175 | 2.143 |
| 91 | 50.2 | 60:40 | 340 | 190 | 1.789 |
| 92 | 49.9 | 60:40 | 370 | 180 | 2.056 |
| 93 | 49.9 | 60:40 | 375 | 175 | 2.143 |
| 94 | 49.9 | 60:40 | 365 | 180 | 2.028 |
| 95 | 50.3 | 60:40 | 330 | 190 | 1.737 |
| 96 | 50.3 | 60:40 | 305 | 200 | 1.525 |
| 97 | 49.9 | 60:40 | 325 | 190 | 1.711 |
| 98 | 49.6 | 60:40 | 370 | 180 | 2.056 |
| 99 | 49.7 | 60:40 | 335 | 190 | 1.763 |
| 100 | 49.8 | 60:40 | 375 | 175 | 2.143 |
| 101 | 40.0 | 75:25 | 285 | 200 | 1.425 |
| 102 | 40.3 | 75:25 | 325 | 190 | 1.711 |
| 103 | 40.0 | 75:25 | 320 | 190 | 1.684 |
| 104 | 39.9 | 75:25 | 335 | 185 | 1.811 |
| 105 | 39.5 | 75:25 | 320 | 195 | 1.641 |
| 106 | 39.0 | 75:25 | 310 | 200 | 1.550 |
| 107 | 38.6 | 75:25 | 310 | 190 | 1.632 |
| 108 | 39.3 | 75:25 | 360 | 180 | 2.000 |
| 109 | 39.0 | 75:25 | 320 | 190 | 1.684 |
| 110 | 39.8 | 75:25 | 350 | 185 | 1.892 |
| 111 | 40.4 | 75:25 | 285 | 200 | 1.425 |
| 112 | 39.8 | 75:25 | 375 | 175 | 2.143 |
| 113 | 49.8 | 75:25 | 430 | 165 | 2.606 |
| 114 | 49.9 | 75:25 | 425 | 165 | 2.576 |
| 115 | 49.9 | 75:25 | 375 | 175 | 2.143 |
| 116 | 49.8 | 75:25 | 370 | 180 | 2.056 |
| 117 | 49.8 | 75:25 | 395 | 170 | 2.324 |
| 118 | 49.8 | 75:25 | 420 | 175 | 2.400 |
| 119 | 49.5 | 75:25 | 400 | 175 | 2.286 |
| 120 | 49.9 | 75:25 | 375 | 175 | 2.143 |
| 121 | 49.7 | 75:25 | 375 | 175 | 2.143 |
| 122 | 49.5 | 75:25 | 330 | 195 | 1.692 |
| 123 | 49.9 | 75:25 | 410 | 170 | 2.412 |
| 124 | 49.6 | 75:25 | 335 | 185 | 1.811 |

TABLE 4
Averages and Standard Deviations

| | | | Foam | Liquid | Foam Volume: |
|---|---|---|---|---|---|
| Ex. | Temp. | N₂O: | Volume | Volume | Liquid |
| Nos. | (° F.) | CO₂ | (mL) | (mL) | Volume |
| 5-16 | 39.9 ± 0.8 | 25:75 | 172 ± 50 | 276 ± 21 | 0.640 ± 0.235 |
| 17-28 | 50.1 ± 0.2 | 25:75 | 235 ± 39 | 254 ± 14 | 0.936 ± 0.206 |
| 29-40 | 40.7 ± 0.3 | 40:60 | 201 ± 45 | 246 ± 20 | 0.836 ± 0.242 |
| 41-52 | 50.0 ± 0.3 | 40:60 | 313 ± 47 | 210 ± 19 | 1.520 ± 0.386 |
| 53-64 | 40.4 ± 0.8 | 50:50 | 216 ± 36 | 238 ± 15 | 0.919 ± 0.208 |
| 65-76 | 49.8 ± 0.2 | 50:50 | 380 ± 41 | 188 ± 14 | 2.051 ± 0.387 |
| 77-88 | 40.1 ± 0.5 | 60:40 | 365 ± 26 | 176 ± 10 | 2.087 ± 0.228 |
| 89-100 | 50.1 ± 0.3 | 60:40 | 353 ± 25 | 183 ± 8 | 1.936 ± 0.217 |
| 101-112 | 39.6 ± 0.6 | 75:25 | 325 ± 27 | 190 ± 8 | 1.716 ± 0.216 |
| 113-124 | 49.8 ± 0.2 | 75:25 | 387 ± 33 | 175 ± 8 | 2.216 ± 0.278 |

### Example 125

This example illustrates the incorporation of foam stabilizing agents into the composition. The compositions summarized in Table 5, where component amounts are expressed in parts by weight, is prepared according to the procedure described for Example 2. Quillaia extract and yucca schidigera extract are each incorporated at 510 parts per million by weight.

TABLE 5

| Component | % wt/wt |
|---|---|
| Water | 82.050 |
| Sugar | 12.400 |
| Skim milk | 3.050 |
| Cream | 0.650 |
| Pectin | 0.225 |
| Propylene Glycol Alginate | 0.200 |
| Gum Arabic | 0.200 |
| Citric Acid | 0.200 |
| Phosphoric Acid | 0.050 |
| Quillaia Extract | 0.051 |
| Yucca schidigera Extract | 0.051 |
| Flavor | q.s. |

### Example 126

### Consumer Testing—CLT (Central Location Test)

This example was conducted to understand the impact of different dissolved gas blends on the consumer acceptance and sensory attributes of a gently carbonated lemon tea. For the purpose of this Example, the “product” refers to the five gently carbonated lemon teas tested. The product was evaluated by a consumer test and using an expert panel trained to evaluate product sensory attribute similarities and differences.

A panel of 100 consumers was convened to evaluate the sensory impact of carbon dioxide versus nitrous oxide in a gently carbonated lemon tea. The panel comprised an equal number of both male and female consumers aged 18 to 55. Each consumer evaluated five lemon tea product samples, including a still tea (labeled as “Lemon Tea”), as well as four carbonated teas (labeled “Gently Carbonated Tea). The lemon tea product samples containing carbon dioxide and/or nitrous oxide containing 2.5 volumes of dissolved gas. The following lemon tea product samples were evaluated.

MG1: Still Product (no carbonation)

MG2: 100% dissolved carbon dioxide

MG3: 50% dissolved carbon dioxide: 50% dissolved nitrous oxide

MG4: 25% dissolved carbon dioxide: 75% dissolved nitrous oxide

MG5: 75% dissolved carbon dioxide: 25% dissolved nitrous oxide

The lemon tea products were presented in a sequential monadic, balanced presentation order. The lemon tea products samples tested contained four refrigerated ounces per sample, following a carbonated serving protocol (product consumed immediately after pouring). Table 7 below summarizes the consumer acceptance and sensory attributes oft gently carbonated lemon tea products.

TABLE 7

| | Non- | | 75% | 50% | 25% |
|---|---|---|---|---|---|
| | Car- | 100% | CO2/25% | CO2/50% | CO2/75% |
| ATTRIBUTE | bonated | CO2 | N20 | N20 | N20 |
| DIAGNOSTICS | (MG-1) | (MG2) | (MG5) | (MG3) | (MG4) |
| CARBONATION | | | | | |
| BUBBLES | | | | | |
| Too Much | | 75% | 45% | 32% | 16% |
| Just About Right | | 25% | 47% | 57% | 52% |
| Not Enough | | | 9% | 11% | 32% |
| OVERALL | | | | | |
| FLAVOR | | | | | |
| Too Strong | 18% | 24% | 25% | 23% | 23% |
| Just About Right | 69% | 45% | 50% | 61% | 64% |
| Too Weak | 13% | 31% | 24% | 17% | 13% |
| LEMON FLAVOR | | | | | |
| Too Strong | 14% | 11% | 17% | 18% | 17% |
| Just About Right | 54% | 48% | 49% | 58% | 54% |
| Too Weak | 32% | 42% | 34% | 23% | 28% |
| TEA FLAVOR | | | | | |
| Toe Strong | 13% | 11% | 16% | 13% | 12% |
| Just About Right | 67% | 41% | 54% | 70% | 65% |
| Too Weak | 20% | 49% | 30% | 17% | 23% |
| BALANCE OF | | | | | |
| LEMON | | | | | |
| Too Much Tea | 24% | 28% | 24% | 21% | 27% |
| Not Enough | | | | | |
| Just About Right | 52% | 46% | 46% | 56% | 50% |
| Too Much Lemon | 23% | 26% | 30% | 22% | 22% |
| Not Enough | | | | | |
| SWEETNESS | | | | | |
| Too Sweet | 29% | 13% | 21% | 31% | 39% |
| Just About Right | 54% | 51% | 49% | 57% | 51% |
| Not Sweet Enough | 17% | 36% | 30% | 12% | 10% |
| SOURNESS/ | | | | | |
| TARTNESS | | | | | |
| Too Sour/Tart | 18% | 30% | 28% | 26% | 24% |
| Just About Right | 56% | 55% | 57% | 59% | 53% |
| Not Sour/Tart | 25% | 15% | 15% | 15% | 22% |
| Enough | | | | | |

Referring to Table 7,

the lemon tea product containing 50% dissolved carbon dioxide and 50% dissolved nitrous oxide was reported as being comparable to the still tea for lemon flavor, tea flavor and balance of lemon to tea flavor, sweetness, and tartness. Further, the increasing nitrous oxide translated into an increase in perceived sweetness. Results among each demographic group (males, females, 18-30 year olds, 31-55 year olds) mirrored the results by total.

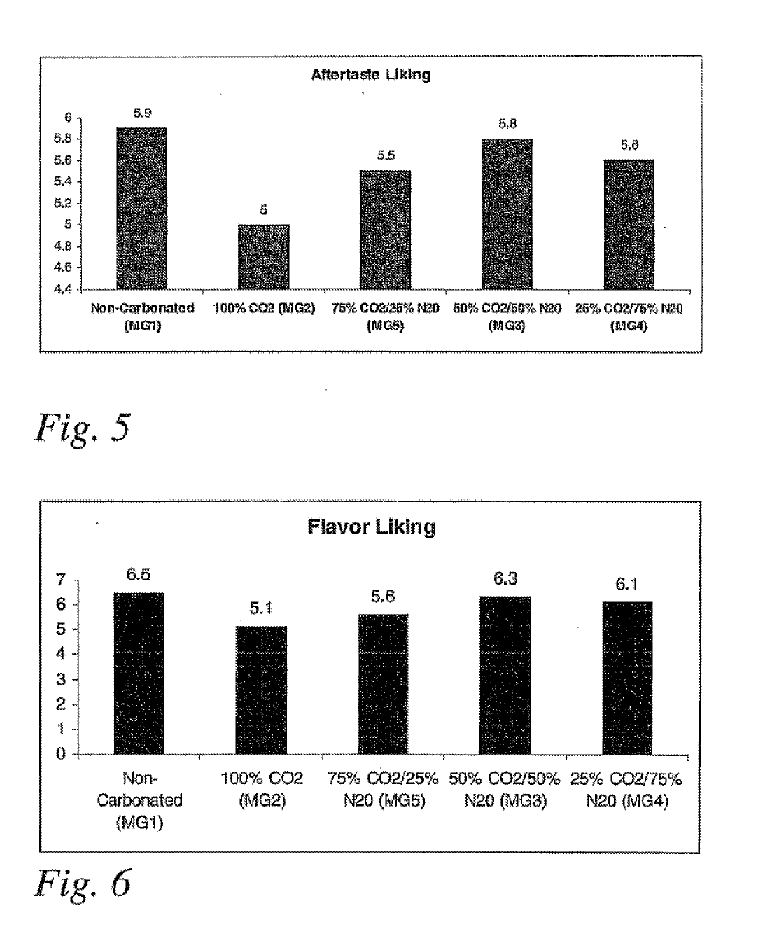

FIG. 5 is a graph demonstrating the “Overall Liking” of each lemon tea product samples, as rated by the consumer panel. The consumers liked the 100% carbon dioxide variant (MG2) the least, as shown in FIG. 5. Consumers were least impressed with the sensory attributes of the 100% carbon dioxide variant, particularly with regard to mouthfeel (FIG. 4), aftertaste (FIG. 5) and flavor (FIG. 6).

FIG. 5 further demonstrates that incremental inclusion of nitrous oxide, from 0% to 25% to 50% led to successive significant bumps in product liking with 50% nitrous oxide and 75% nitrous oxide variants earning statistical parity to the non-carbonated tea.

### Example 127

### Trained Description Sensory Panel (Lemon Tea Beverages)

A 14 member Trained Descriptive Sensory Panel was convened to evaluate product sensory attribute similarities and differences, using the Tragon QDA® research method. Tragon QDA® is a trained panel research method that measures sensory attribute similarities and differences.

Each panelist evaluated five lemon tea product samples, including a still tea (labeled as “Lemon Tea”), as well as four carbonated teas (labeled “Gently Carbonated Tea). The lemon tea product samples containing carbon dioxide and/or nitrous oxide containing 2.5 volumes of dissolved gas. The following lemon tea product samples were evaluated.

MG1: Still Product (no carbonation)

MG2: 100% dissolved carbon dioxide

MG3: 50% dissolved carbon dioxide 50% dissolved nitrous oxide

MG4: 25% dissolved carbon dioxide: 75% dissolved nitrous oxide

MG5: 75% dissolved carbon dioxide: 25% dissolved nitrous oxide

A 4 oz. product serving was presented in 5 oz. clear plastic cups at a serving temperature of 42+/−2° C. The 14 member panel evaluated each product 3 times with breaks provided between products. During each break, panelists cleansed their palates with unsalted crackers and room temperature water.

At the onset of the study, the 14 member panel convened during language development sessions to discuss and agree upon a common language to fully describe the product included in the test. The panel identified 60 sensory terms, including 4 terms directed to appearance, 17 terms directed to aroma, 21 terms directed to flavor, 3 terms directed to mouthfeel, and 15 terms directed to aftertaste/after effect. The 60 sensory terms are provided in Table 8.

TABLE 8

| | |
|---|---|
| APPEARANCE | Observe product by lifting and looking through the |
| | product by holding it toward the light. |
| | Tilt the cup, but do not swirl. |
| Color | Color of product ranging from tan to burnt orange, |
| | reddish, amber, or rust sometimes with a green tinge. |
| | Similar to apple juice. |
| Cloudiness | Amount of murky or dirty quality to the product. |
| Amount of | Quantity of floaties, sediment or solid bits, throughout |
| Particles | the product. |
| Amount of bubbles | Number of bubbles present in the product or on the |
| | surface similar to froth or foam. |
| AROMA | Evaluate the aroma with short sniffs. Clear your nose |
| | by sniffing your napkin. |
| Overall tea aroma | Amount of overall tea aroma. |
| Overall citrus | Amount of overall citrus aroma. |
| aroma | |
| Nose Tingle | A crisp, fresh, spicy, sour or biting sensation |
| | in the nose. |
| Tobacco | The aroma of loose or chewing tobacco, hay |
| | or black tea. |
| Lemon | An aroma of characteristic of fresh lemon, lemon |
| | zest, and lemon candy. |
| Honey | A sweet aroma associated with brown sugar |
| | and honey. |
| Fruity | A fruity aroma characteristic of apple juice, |
| | fresh apples, or Fruit Loops. |
| Earthy | An aroma associated with dirt, fertilizer or earth. |
| Herbal | A green aroma associated with verbena, fresh |
| | cut grass or lemon grass. |
| Other Citrus | An aroma characteristic of fresh orange, lime |
| | or citrus zest or peel. |
| Fermented | A vinegar or Alcohol aroma associated with |
| | rotting fruit. |
| Vanilla | An aroma associated with vanilla extract or |
| | vanilla bean. |
| Vegetable | An aroma associated with tomato, ketchup, |
| | clamato, potato, carrot or celery. |
| Cinnamon | An aroma associated with cinnamon, ground, |
| | sticks or candy. |
| Metallic | An aroma associated with metal or tin can. |
| Chemical | An aroma associated with cleaner, bleach or |
| | Lemon Pledge. |
| Mentholyptus | The aroma of menthol, eucalyptus, mint or vapor rub. |
| Ashy | The aroma of ashes, ash tray or smoke. |
| FLAVOR | Evaluate product while it is in the mouth and |
| | immediately after swallowing or spitting. |
| Overall Tea | Amount of overall tea flavor. |
| Overall Citrus | Amount of overall citrus flavor. |
| Sweet | Amount of sweet flavor. |
| Tart | Amount of tart flavor. |
| Salty | Amount of salty flavor. |
| Bitter | Amount of bitter flavor. |
| Lemon | Flavor characteristic of lemon juice, zest or |
| | candy. |
| Other Citrus | Flavor characteristic of orange or lime juice, |
| | zest or candy. |
| Fruity | Flavor characteristic of apple, pomegranate |
| | or Fruit Loops. |
| Fermented | A flavor associated with vinegar, alcohol or |
| | spoiled, overripe fruit. |
| Honey | A sweet flavor associated with brown sugar, floral |
| | honey, and honeysuckle. |
| Chemical | A plastic flavor characteristic of bleach, cleaner |
| | or Lemon Pledge. |
| Herbal | A green grassy flavor associated with verbena |
| | or green tea leaves. |
| Vegetable | Flavor associated with tomatoes, celery, |
| | potato and carrots. |
| Cinnamon | Flavor associated with cinnamon, ground, |
| | stick or candy. |
| Mentholyptus | Flavor associated with menthol, mint, eucalyptus, |
| | or vapor rub. |
| Ginger | Flavor associated with ginger root, powder or candy. |
| Metallic | Flavor associated with tin can. |
| Earthy | Flavor associated with dirt, fertilizer or earth. |
| Tobacco | Flavor associated with chewing tobacco, loose |
| | tobacco, hay or black tea. |
| Ashy | Flavor associated with ashes, ash tray or smoke. |
| MOUTHFEEL | Evaluate attribute while product is in the mouth or |
| | immediately after spitting or swallowing. |
| Mouthcoating | A residual film in the mouth. |
| Thickness | Amount of viscosity from thin and watery to |
| | thick and syrupy. |
| Drying | Amount of chalky and astringent feel in the mouth. |
| AFTERTASTE/ | Take a sip and wait 30 seconds before evaluating |
| AFTEREFFECTS | product. |
| Overall aftertaste/ | Amount of overall aftertaste or aftereffects |
| Aftereffects | remaining in the mouth after swallowing. |
| Sweet | Amount of sweet taste remaining in the mouth. |
| Tart | Amount of tart taste remaining in the mouth. |
| Bitter | Amount of bitter taste remaining in the mouth. |
| Lemon | Lingering taste associated with lemon juice, |
| | zest or candy. |
| Tobacco | Lingering taste associated with brewed tea or |
| | loose tobacco. |
| Other citrus | Lingering taste associated with orange or lime |
| | juice, zest or candy. |
| Residue | Residue left in the mouth, which may be similar |
| | to the feeling of syrup coating in the mouth. |
| Ashy | Lingering flavor associated with ashes, ash tray |
| | or smoke. |
| Stale | A dirty, old, or stale taste left in the mouth. |
| Chemical | Lingering flavor associated within cleaner, Clorox, |
| | and Lemon Pledge. |
| Mentholyptus | lingering flavor associated with menthol, mint, |
| | eucalyptus, or vapor rub. |
| Salivating | Lingering salivation after swallowing or spitting. |
| Burning | Feeling of abrasion on the mouth lips or tongue |
| | similar to the effect of eating fresh pineapple. |
| Drying | Amount of chalky and astringent feel lingering |
| | in the mouth. |

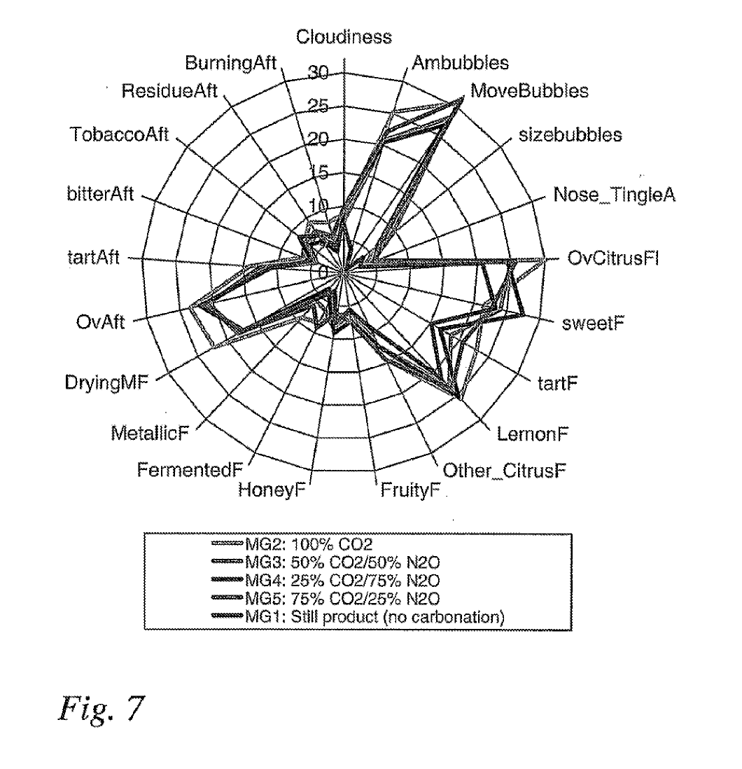

The descriptive results of the 14 member Trained Descriptive Sensory Panel are summarized in Table 9. FIG. 7 is a graph demonstrating the data provided in Table 9, comparing the five lemon tea product samples.

TABLE 9

| | | | | | MG1: |
|---|---|---|---|---|---|
| | | MG3: | MG4: | MG5: | Still |
| | | 50% | 25% | 75% | product |
| | MG2: | CO₂/ | CO₂/ | CO₂/ | (no |
| | 100% | 50% | 75% | 25% | carbon- |
| | CO₂ | N₂O | N₂O | N₂O | ation) |
| Overall | 5.1553 | 6.5049 | 6.3689 | 5.8932 | 6.6602 |
| Opinion | | | | | |
| Cloudiness | 8.812 | 7.8182 | 9.4545 | 9.7364 | 7.2636 |
| Ambubbles | 25.1818 | 20.7545 | 20.3727 | 22.1273 | 3.6727 |
| Movebubbles | 30.7636 | 28.0091 | 26.6455 | 31.3545 | 0.6455 |
| Sizebubbles | 6.4182 | 9.4182 | 6.5091 | 7.1455 | 3.7 |
| Nose_TingleA | 3.4364 | 4.5727 | 4.8818 | 5.1455 | 2.6364 |
| OvCitrusFl | 30.1091 | 24.9273 | 24.4545 | 25.7182 | 20.7364 |
| SweetF | 21.4455 | 23.9909 | 27.4273 | 22.6818 | 23.2364 |
| TartF | 22.9182 | 18.5091 | 16.6727 | 20.5727 | 15.1091 |
| LemonF | 25.6727 | 23.1545 | 25.2182 | 23.7273 | 21.4182 |
| Other_Citrus | 14.3091 | 12.1727 | 12.2909 | 14.3273 | 9.0091 |
| FruityF | 6.2273 | 5.7091 | 7.2636 | 7.5818 | 5.5727 |
| HoneyF | 6.4 | 8.7273 | 9.1364 | 6.1273 | 7.5909 |
| FermentedF | 8.3091 | 6.2364 | 4.8 | 9.1 | 2.9909 |
| ChemicalF | 3.5818 | 2.1 | 0.8727 | 3.5636 | 2.1818 |
| MetallicF | 9.1455 | 5.7636 | 3.2545 | 6.6182 | 4.8455 |
| DryingMF | 22.2091 | 18.1636 | 17.1727 | 17.8273 | 17.3727 |
| OvAft | 23.3909 | 20.8091 | 21.6636 | 20.6909 | 21.9545 |
| TartAft | 14.0182 | 12.0091 | 10.9455 | 12.4182 | 10.8 |
| BitterAft | 6.5091 | 4.4273 | 4.3 | 4.5182 | 5.2182 |
| TobaccoAft | 7.4909 | 6.3091 | 6.6909 | 7.2818 | 8.5636 |
| ResidueAft | 9.1455 | 7.4364 | 5.6636 | 7.5909 | 6.7455 |
| BurningAft | 7.9364 | 5.4091 | 3.3545 | 5.7727 | 4.1727 |

The descriptive results provided by the 14 member Trained Descriptive Sensory Panel confirm and support the consumer test results provided in Example 126 above. In particular, the 100% carbon dioxide variant was liked the least due to higher tart and bitter, high mouthfeel (drying, burning and residue). As the amount of carbon dioxide decreased, the tart, bitter flavor, drying, burning mouthfeel and off notes decreased.

The 14 member Trained Descriptive Sensory Panel further reported that the 100% carbon dioxide variant had noticeable off notes including metallic off notes and chemical off notes. Increasing amounts of nitrous oxide reduced the metallic off notes.

Further, the increasing nitrous oxide translated into an increase in perceived sweetness.

Among the carbonated variants, the lemon tea product containing 50% dissolved carbon dioxide: 50% dissolved nitrous oxide was reported as having the most balanced profile, which confirms the results of the consumer test results.

### Example 128

### Trained Description Sensory Panel (Chocolate Beverages)

A 12 member Trained Descriptive Sensory Panel was convened to evaluate product sensory attribute similarities and differences, using the Tragon QDA® research method described previously. Each panelist evaluated two chocolate beverage product samples, including a first chocolate-beverage soda with dissolved carbon dioxide and a second chocolate-beverage soda including a mixture of nitrous oxide and carbon dioxide in a volume/volume ratio of about 50:50. The total volume of dissolved gas in the first chocolate-beverage soda was about 2.4 volumes. For the second chocolate-beverage soda, the total volume of dissolved gas in the 50:50 mixture of nitrous oxide and carbon dioxide was about 3.9 volumes.

The two chocolate beverages were each prepared using a fudge-flavored chocolate base as shown in Table 10.

TABLE 10

| Component | Mass (gm) | % (wt/wt) |
|---|---|---|
| Water | 965.00 | 92.23 |
| Potassium Benzoate | 3.58 | 0.34 |
| Sodium Acid Sulfate | 1.20 | 0.11 |
| Lactic Acid | 0.30 | 0.03 |
| Aspartame | 0.60 | 0.06 |
| Acesulfame Potassium | 0.24 | 0.02 |
| Sucralose | 0.60 | 0.06 |
| Sucrose | 50.00 | 4.78 |
| Fudge-Flavored Concentrate | 20.50 | 1.96 |
| Other Flavors | 4.30 | 0.41 |

Each of the chocolate beverages was prepared by dilution of the beverage base in water. The base was diluted with addition of about 1 part of the base to about 5 parts water.

A 4 oz. product serving was presented in 5 oz. clear plastic cups at a serving temperature of 42±2° C. The 12 member panel evaluated each product 3 times with breaks provided between products. During each break, panelists cleansed their palates with unsalted crackers and room temperature water.

At the onset of the study, the 12 member panel convened during language development sessions to discuss and agree upon a common language to describe the product included in the test. Above any terms previously defined in Table 8, the panel identified various terms as defined in Table 11.

TABLE 11

| Term | Description |
|---|---|
| Milk Chocolate | Characteristic of chocolate that has creamy, malty and |
| | dairy notes, similar to the candy tootsie rolls |
| Dark Chocolate | Characteristic of the darker notes of chocolate; cocoa |
| | bean, coffee |
| Vanilla | Characteristic of vanilla bean, vanillin and/or vanilla |
| | extract |
| Caramel | Characteristic of cooked or brown sugar |
| Thickness | The feeling of the product when initially in the mouth |
| | ranging from thin and watery to thick and syrupy |
| Fizzy | Characteristic to the bite provided when a product is |
| | carbonated; from low being ‘flat’ to high being tonic |
| | water |
| Drying | Feeling astringent or drawing in the mouth |
| | characteristic of alum or grape juice |
| Mouthcoating | Residue left in the mouth which may be similar to the |
| | feeling of syrup coating in the mouth, throat or on the |
| | teeth |
| Abrasion | Intensity of burning similar to a scrape, characteristic |
| | of eating high acid foods such as fresh pineapple |

The descriptive results of the 12 member Trained Description Sensory Panel are summarized in Table 12.

TABLE 12

| | Chocolate | Chocolate Beverage |
|---|---|---|
| Descriptive Analysis | Beverage (CO₂) | (CO₂ and N₂O) |
| Color Intensity AP | 63.9 | 62.5 |
| Milk Chocolate Aroma | 43.6 | 55 |
| Dark Chocolate Aroma | 51.5 | 44 |
| Vanilla Aroma | 38 | 41.3 |
| Caramel Aroma | 29 | 35.2 |
| Sweet Flavor | 53.8 | 62.2 |
| Tart Flavor | 24 | 24 |
| Bitter Flavor | 29.3 | 23.6 |
| Milk Chocolate Flavor | 41.8 | 57 |
| Dark Chocolate Flavor | 50.4 | 37.8 |
| Vanilla Flavor | 38.1 | 43.7 |
| Caramel Flavor | 30.1 | 35.7 |
| Drying Mouthfeel | 43.6 | 41 |
| Thickness Mouthfeel | 26.3 | 26.3 |
| Mouthcoating Mouthfeel | 33.3 | 34.2 |
| Fizzy Mouthfeel | 24.4 | 29.2 |
| Sweet Aftertaste | 42.7 | 50.5 |
| Tart Aftertaste | 21.1 | 20.6 |
| Bitter Aftertaste | 26.6 | 22.3 |
| Milk chocolate Aftertaste | 33.8 | 44.7 |
| Dark Chocolate Aftertaste | 40.6 | 28.5 |
| Vanilla Aftertaste | 31.3 | 34.7 |
| Caramel Aftertaste | 24.9 | 28 |
| Mouthcoating Aftertaste | 31.9 | 32.3 |
| Drying Aftertaste | 44 | 37.5 |
| Abrasion Aftertaste | 31.5 | 31.3 |

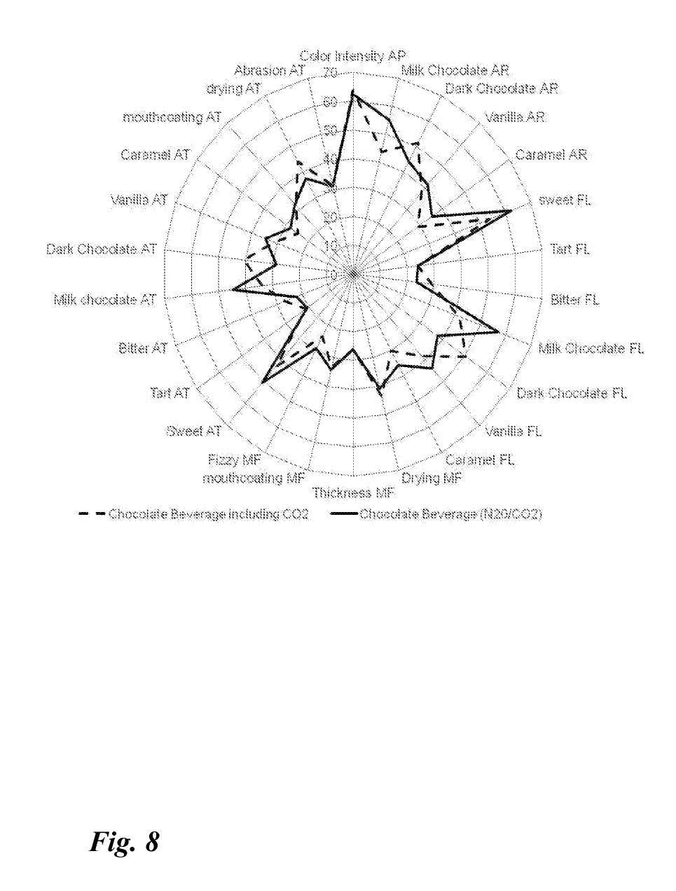

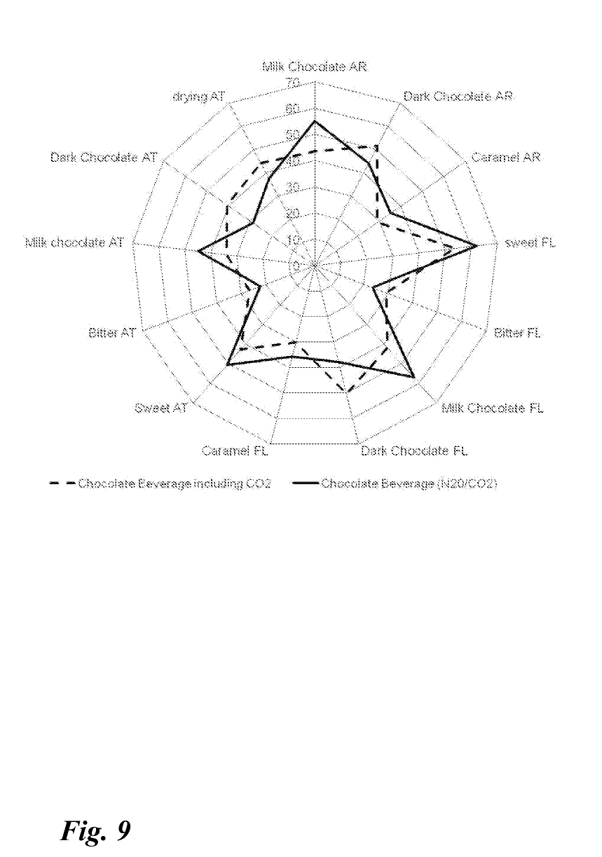

The data in Table 12 is shown in graphical form in FIG. 8. For clarity, a subset of the most significant data from Table 12 is also shown in FIG. 9. A number of significant differences are evident from the data. For example, the chocolate beverage including both dissolved nitrous oxide and dissolved carbon dioxide was characterized as having a significantly higher milk chocolate aroma as well as caramel aroma. The chocolate beverage including dissolved carbon dioxide without dissolved nitrous oxide was characterized as having a significantly higher dark chocolate aroma. In addition, the chocolate beverage including both dissolved nitrous oxide and dissolved carbon dioxide was characterized as having a significantly higher sweet, milk chocolate, and caramel flavor. The chocolate beverage including dissolved carbon dioxide without dissolved nitrous oxide was characterized as having a significantly higher dark chocolate flavor. Furthermore, the chocolate beverage including both dissolved nitrous oxide and dissolved carbon dioxide was characterized by significantly higher sweet and milk chocolate aftertaste. The chocolate beverage including dissolved carbon dioxide without dissolved nitrous oxide was characterized by significantly higher bitter, dark chocolate, and drying aftertaste. The chocolate beverage including both dissolved nitrous oxide and dissolved carbon dioxide was characterized by significantly higher fizzy mouthfeel. In addition, the chocolate beverage including both dissolved nitrous oxide and dissolved carbon dioxide was characterized as providing a coating mouthfeel and thickness mouthfeel at least on par or better than the chocolate beverage including only carbon dioxide as a dissolved gas. Thus, these results indicate that nitrous oxide may be present in an amount sufficient to increase a milk chocolate flavor and a sweet flavor of the beverage. In addition, these results indicate that nitrous oxide may be present in an amount sufficient to increase the mouthfeel of the beverage.

The term “or” means “and/or”. As used herein the transitional term “comprising,” (also “comprises,” etc.) which is synonymous with “including,” “containing,” or “characterized by,” is inclusive or open-ended and does not exclude additional, unrecited elements or method steps, regardless of its use in the preamble or the body of a claim.

l The endpoints of all ranges directed to the same component or property are inclusive of the endpoint and independently combinable.

All patents and other references identified by number herein are incorporated by reference in their entirety.

While many examples in this document refer to compositions, beverages, mixes or syrups, or concentrates, it is understood that those materials are described in an exemplary manner only and that other compositions may be used. For example, any feature in one embodiment may be used in any other embodiment. Additionally, other ingredients may be used, depending on the particular needs. Although the foregoing specific details describe certain embodiments, persons of ordinary skill in the art will recognize that various changes may be made in the details of these embodiments without departing from the spirit and scope of this invention as defined in the appended claims and considering the doctrine of equivalents. Therefore, it should be understood that this invention is not limited to the specific details shown and described herein.

What is claimed is:

1. A beverage comprising:
a chocolate-flavored concentrate;
at least one high intensity sweetener; and
dissolved gas comprising a mixture of nitrous oxide and carbon dioxide in a volume ratio of about 75:25 to about 25:75;
wherein the beverage contains from about 1.0 to about 4.5 volume (%) of said dissolved gas;
wherein said dissolved nitrous oxide is present in an amount sufficient to increase a milk chocolate flavor and a sweet flavor of said beverage.

2. The beverage of claim 1 wherein said at least one high intensity sweetener possesses one or more bitter off notes;
wherein the nitrous oxide is present in an amount sufficient to diminish said bitter off notes.

3. The beverage of claim 2 wherein said beverage provides about 2 calories to about 8 calories per fluid ounce.

4. The beverage of claim 1 wherein said at least one high intensity sweetener comprises aspartame, acesulfame-potassium, and sucralose.

5. The beverage of claim 4 wherein said aspartame is between about 50 ppm to about 250 ppm;
wherein said acesulfame-potassium is between about 15 ppm to about 75 ppm;
wherein said sucralose is between about 50 ppm to about 250 ppm.

6. The beverage of claim 1 wherein said chocolate-flavored concentrate comprises a fudge-flavored concentrate.

7. The beverage of claim 6 wherein said fudge-flavored concentrate comprises a source of said milk chocolate flavor in the beverage and also provides a dark chocolate flavor to said beverage;
wherein said dissolved gas increases a perception of said milk chocolate flavor over the dark chocolate flavor in said beverage.

8. The beverage of claim 1 wherein said dissolved gas is present in an amount sufficient to increase the mouthfeel and texture of said beverage.

9. The beverage of claim 8 wherein said beverage provides about 2 to about 8 calories per fluid ounce.

10. The beverage of claim 1 wherein said dissolved gas consists of a mixture of nitrous oxide and carbon dioxide in a volume ratio of about 75:25 to about 25:75.

11. The beverage of claim 1 wherein said dissolved gas consists of a mixture of nitrous oxide and carbon dioxide in a volume ratio of about 50:50.

12. A beverage comprising:
a fudge-flavored concentrate;
aspartame in a concentration of about 50 ppm to about 250 ppm;
acesulfame-potassium in a concentration of about 15 ppm to about 75 ppm;
sucralose in a concentration of about 50 ppm to about 250 ppm; and
dissolved gas consisting of a mixture of nitrous oxide and carbon dioxide in a volume ratio of about 75:25 to about 25:75;
wherein the beverage contains from about 1.0 to about 4.5 volume (%) of said dissolved gas;
wherein the nitrous oxide is present in an amount sufficient to increase a milk chocolate flavor and a sweet flavor of said beverage.

13. The beverage of claim 12 wherein said beverage provides about 2 to about 8 calories per fluid ounce.

14. The beverage of claim 12 wherein said beverage provides about 4 to about 6 calories per fluid ounce.

15. The beverage of claim 12 wherein the nitrous oxide is present in an amount sufficient to diminish bitter off notes associated with a combination of said aspartame, said acesulfame-potassium, and said sucralose.

16. The beverage of claim 12 wherein said fudge-flavored concentrate comprises a source of said milk chocolate flavor in the beverage and also provides a dark chocolate flavor to said beverage;
wherein said dissolved gas increases a perception of said milk chocolate flavor over the dark chocolate flavor in said beverage.

17. The beverage of claim 12 wherein said dissolved gas consists of a mixture of nitrous oxide and carbon dioxide in a volume ratio of about 50:50.

18. The beverage of claim 12 wherein said dissolved gas is present in an amount sufficient to increase the mouthfeel and texture of said beverage.

19. A beverage comprising:
a foam-creating composition comprising a dairy composition and a hydrocolloid composition;
wherein the foam-creating composition comprises about 55 to about 95 wt % of the dairy composition based on the total weight of the foam-creating composition, and wherein the dairy composition comprises a dairy protein;
wherein the foam-creating composition comprises a ratio of dairy protein to hydrocolloid of about 1:1.5 wt/wt to about 1:3 wt/wt;
a fudge-flavored concentrate;
aspartame in a concentration of about 50 ppm to about 250 ppm;
acesulfame-potassium in a concentration of about 15 ppm to about 75 ppm;
sucralose in a concentration of about 50 ppm to about 250 ppm; and
dissolved gas consisting of a mixture of nitrous oxide and carbon dioxide in a volume ratio of about 75:25 to about 25:75;
wherein the beverage contains from about 1.0 to about 4.5 volume (%) of said dissolved gas;
wherein the nitrous oxide is present in an amount sufficient to increase a milk chocolate flavor and a sweet flavor of said beverage.

20. The beverage of claim 19 wherein said nitrous oxide is present in an amount sufficient to diminish bitter off notes associated with a combination of said aspartame, said acesulfame-potassium, and said sucralose.
